(19) United States
(12) Patent Application Publication
(10) Pub. No.: US 2024/0369820 A1
(43) Pub. Date: Nov. 7, 2024

(54) MADE-IN-SPACE TELESCOPES

(71) Applicant: IGOR ABRAMOV, VISTA, CA (US)

(72) Inventor: IGOR ABRAMOV, VISTA, CA (US)

(21) Appl. No.: 18/141,476

(22) Filed: May 1, 2023

(51) Int. Cl. G02B 23/02; B64G 1/10; B64G 1/22

(52) U.S. Cl. CPC G02B 23/02; B64G 1/105; B64G 1/222; B64G 1/1057

(57) ABSTRACT

Disclosed is a made-in-space telescope (52a) comprising primary mirror made by spinning liquid precursor in two orthogonal axes to form a paraboloid surface and subsequently allowing or causing it to solidify. Several mirror material variants are disclosed. Depending on mirror material used, it can be subsequently coated with reflecting coating.

Extended/deployed (120a) or formed (130) boom assists in controlling the spin of the telescope for mirror forming.

Several telescope embodiments based on the boom design are disclosed.

Boom variants include 3-D printed/extruded (130), corrugated (120), telescopic (190a), coiled (192a), folded (193c), taut cable (195a), stiffened cable ((197), and compound boom made with anisotropically pliable elements (198).

Several system elements such as primary mirror support (42a), supporting struts (160) and (162), and several boom variants (120), (140), (192a) are made with shape memory materials and deploy from their stowed configurations upon being heated.

Heat pipe based implementations are additionally disclosed for heat-activated shape memory system elements.

### CROSS-REFERENCE TO RELATED APPLICATION

This is a continuation-in-part of U.S. application Ser. No. 17/884,569 filed on 2022 Oct. 8 titled “SPACE-BORNE IMAGING SYSTEM” which is a continuation-in-part of U.S. application Ser. No. 17/443,395 filed on 2021 Oct. 10 titled “IMAGING TELESCOPE”, which is a continuation-in-part of U.S. application Ser. No. 16/838,035 filed on 2020 Apr. 4 titled “IMAGING TELESCOPE”, now U.S. Pat. No. 11,604,289 titled “SPACE-BORNE TELESCOPE HAVING MIRROR FORMED FROM LIQUID AND TWO-AXIS ROTATIONAL CONFIGURATION” which is incorporated herein in its entirety by reference and claims priority benefits thereof.

### FIELD OF INVENTION

This invention relates in general to space-borne imaging systems and in particular to space-borne and made-in-space telescopes.

### BACKGROUND OF INVENTION

At present, space-borne imaging systems, such as telescopes are equipped with high resolution imaging systems (usually with approximately 1-meter diameter imaging mirrors), space-borne telescopes such as Hubble (with 2.4-meter diameter monolithic primary mirror) and James Webb (with 6.5-meter diameter compound primary mirror), are large in order to accommodate large optical structures required for high resolution imaging.

A primary telescope mirror is customarily made of a single piece, such as a Hubble telescope's, or several pieces, as is the case of the Webb telescope of highly polished stable material such as glass, beryllium or silicon carbide. The mirror has to be mechanically securely supported during launch to prevent damage to itself as well as potential damage to the telescope or the launch vehicle. The mirror launch support(s) introduce considerable added weight and bulk to the overall telescope imaging system, complicating its packaging for launch, increasing launch costs and limiting selection of launch vehicles.

Also, space-bound telescopes with very large apertures cannot be launched with a single monolithic primary mirror due to its size. They, like the Webb, have to use several mirror elements precisely assembled, deployed and aligned into a single reflecting structure upon reaching its destination in space. In case of the Webb telescope, its eighteen individual mirror elements are precisely aligned with actuators to form a single image as would be created by a monolithic mirror.

These requirements exert extraordinary demands on the mirror support and deployment structures, both to survive the launch stresses and to ensure reliable and ultra-precise deployment and positioning of the individual mirror elements into a unified reflecting structure.

The ideal shape for a celestial telescope primary mirror is that of a paraboloid. Most telescope mirrors, however, are made to be spherical due to the easier/less expensive fabrication processes, which necessitates addition of corrective optics for high quality imaging performance.

Yet, there are other ways of making paraboloid reflective surfaces. One such way, on Earth, is to spin a liquid in a horizontal plane which, with this spinning together with Earth's gravity, forms a paraboloid surface on the liquid. This effect has been known since 1600's and analyzed by Sir Isaac Newton.

It is also possible to make such shapes even in space in zero gravity if one creates an artificial gravity.

The disclosed invention enables making mirrors of large, and very large diameters, in the order of tens of meters, in space, and incorporating them into space-borne telescopes designed specifically to participate in creation of-and incorporate within them, these mirrors, all while in space.

Space telescopes using these mirrors would have an unprecedented optical resolution and light gathering capability and would enhance optical imaging both for terrestrial objects as well as for deep space exploration.

### OBJECTIVES OF THE INVENTION

Thus, it is the objective of instant invention to provide a process of making telescopes in space.

Another objective is to provide a space-borne telescope which would not require complex and heavy structural supports to its imaging mirror during launch or during its erection.

Another objective is to provide a space-borne telescope whose primary imaging mirror surface would be formed entirely in space.

Yet another objective is to provide a space-borne telescope whose imaging mirror would be formed as a single piece.

Another objective is to provide a space-borne telescope whose imaging mirror would be lightweight.

Yet another objective is to provide space-borne telescope whose imaging mirror would be repairable in space, without instruments or structures in addition to the ones used for mirror generation.

### SUMMARY OF THE INVENTION

In accordance with the present invention, described is a free-floating telescope structure with an imaging mirror or mirrors formed in space. The described telescope structure comprises a deployable mirror support and a deployable boom.

The boom is made to be very long and slender, preferably smaller in diameter than the secondary telescope mirror (if the telescope is of a folded Cassegrain-type design) or an imaging camera positioned along the optical axis of the primary mirror, so as to not obscure more incident light than these essential imaging structures.

The boom, deployed from its stowed configuration or entirely made in space in a 3-D printed/extruded operation. It can be made foldable, made of shape memory materials, uncoiling helical, telescopic with several types of extension mechanisms, be a flexible cable unfolded/extended/stretched by a tractor craft or projectile released from the main telescope body, or be unrolled from a coil and stiffened.

The boom can be retained after the primary mirror has been made, or it can be optionally jettisoned upon completion of the telescope.

In case of 3-D printing of the boom, the 3-D printer or extruder travels in the distal direction from telescope's main body as it builds the boom, and after it completes making of the boom, serves as a counterweight for the subsequent structure rotation during the mirror generation.

Alternatively, the 3-D printer or extruder can be stationary with the produced boom extending outward from it as it is being formed.

Still alternatively, the boom can be a cable unwound and stretched by a tractor craft or projectile released from the main telescope body and kept in tension by this craft or projectile while the mirror is formed. Alternatively, such cable can be stiffened by coating it with stiffening materials as it is being paid out.

Another variation of an unwound-type boom can comprise two or more longitudinal members with curved cross-sections (akin to a retractable tape measure) held together by special holders upon unwinding to impart stiffness to the assembly.

On its end the boom may contain a dedicated counterweight, to assist in controlled spinning of the telescope system or the very weight of the boom itself can be used as a counterweight.

The boom may also contain propulsion system which would rotate the telescope.

The primary mirror is made by deploying a mirror support, preferably in a paraboloid shape (but, by necessity lacking a mirror surface or precision cross-section), or even a pliable material, spinning this support in two orthogonal axes around the center of mass of the telescope-boom assembly, injecting liquid mirror precursor onto this mirror support, allowing the precursor to assume the paraboloid shape, and subsequently solidifying this precursor into a completed mirror by cooling it off, or polymerizing it either as a result of using a 2-part epoxy for its composition or, in case of a photopolymer, cross-linking it with a UV light.

The mirror's paraboloid shape is formed by a liquid photopolymer or other liquid precursors which assume paraboloid shape upon specific rotational maneuvers of the telescope platform itself, and which subsequently harden or made to harden into a solid paraboloid shape.

When a photopolymer is used for mirror material it is subsequently solidified into a mirror preform via crosslinking by exposing it to ultra-violet (‘UV’) illumination supplied by the system's light source(s) for that purpose, or by exposing the preform to sunlight which has significant UV content in space, or exposing it to gamma rays from a radio nucleotide source contained in the system.

If an alternative liquid precursor, such as liquid mercury, molten metal, thermoset-and thermoplastic polymers, or two-part epoxy is used, it is allowed to cool and solidify on its own prior to cessation of the structure rotation, thus preserving its paraboloid shape and create a mirror.

While metals can solidify with highly reflective surfaces, for non-metallic liquid precursors a reflecting metallic or dielectric layer(s) are subsequently deposited on the formed paraboloid mirror preform, by various deposition techniques effected by specialized apparatuses of the described telescope system.

Shape-memory materials are used extensively in proposed systems for the mirror support itself, deployment and positioning system elements supports and some boom variants.

The mirror support, the boom and the deployable supports remain in their respective compact stowed configurations until deployment.

The deployment of memory shape elements is effected by heating them.

The heating of the deployable elements is provided preferably by an electric current passed directly through them. Alternatively, it can be provided by dedicated heating elements. In emergency, elements' heating can be accomplished by exposure to sunlight.

After deployment of the mirror support, the boom and the supports the structure is spun simultaneously around two orthogonal axes: one to generate artificial gravity and another to provide radial acceleration to the mirror support, while a liquid mirror precursor is deposited onto it.

As a result of this compound rotation, the liquid precursor assumes a paraboloid shape. It is then either allowed to cool/solidify (in case of molten materials or mixed epoxies), or crosslinked with a UV light (in case of photopolymers).

Afterwards, thusly formed paraboloid surface can be either left as-is (in case of solidified metals), or coated with reflective materials such as metals, or multi-layer reflecting coatings. For the latter, a coating system is included in the structure.

Articles made with shape-memory materials, their fabrication, shape ‘training’ and usage are known in their respective arts.

3-D printing of structures in vacuum of space has been proposed but has not been accomplished at present yet, but 3-D printing in zero-g environment has.

### PRIOR ART

It has been known since 1600's that a surface of liquid spun around a vertical axis assumes a paraboloid shape. On the surface of the Earth paraboloid telescope mirrors created with spinning layer of liquid mercury have also been known for some time. Indeed, relatively recent NASA Liquid Mirror Telescope (‘LMT’) and Canadian Large Zenith Telescope (‘LZT’) are just examples of such spinning mercury large telescopes. These telescopes share a common shortcoming, however: they can only be pointed vertically (i.e. towards zenith) and cannot be aimed in other directions.

The U.S. Pat. No. 11,604,289 titled “IMAGING SATELLITE HAVING MIRROR FORMED FROM LIQUID AND TWO-AXIS ROTATIONAL CONFIGURATION” to the present inventor describes making a paraboloid mirror in space by spinning a telescope with mirror support in two orthogonal axes thus forming a paraboloid mirror from a liquid precursor.

Two patent applications filed by the present inventor, U.S. Ser. No. 17/443,395 titled “IMAGING SATELLITE” and U.S. Ser. No. 17/884,569 titled “SPACE-BORNE IMAGING SYSTEM” are also extant. The present invention builds upon all of them as a continuation-in-part.

There have been proposals for paraboloid mirrors spin-cast from epoxy (US H2123 to Mollenhauer et al., U.S. Pat. No. 6,254,243 to Scrivens, U.S. Pat. No. 6,533,426 to Carreras et al.), made of magnetic rheological fluids, etc.

There have also been non-industrial attempts to cast paraboloid mirrors with epoxy materials utilizing horizontal rotational tables, with varying success.

There have also been several deployable paraboloid radio antenna reflectors based on shape-memory materials which resemble in their shape the final shape of the proposed paraboloid mirror.

For example, U.S. Pat. Nos. 11,322,851 and 11,398,681, both to present inventor, teach a shape-memory deployable rigid paraboloid antenna reflector and a paraboloid antenna based on shape-memory deployable rigid ribs supporting a flexible reflector, respectively.

Also, U.S. Pat. No. 7,710,348 to Taylor et al. teaches a deployable antenna reflector which utilizes a shape-memory element to open conventional rigid ribs supporting a flexible reflector.

U.S. Pat. Nos. 8,259,033 and 9,281,569, both to Taylor et al. teach a deployable antenna reflector with longitudinal and circumferential shape-memory stiffeners supporting a reflective elastic material.

None of the prior art above, with the exception of the continuations-in-part cited by present inventor and incorporated within present application, suggests or teaches a free-floating telescope structure with a paraboloid mirror created in space.

None of the prior art suggests or teaches a deployable or created boom structure.

None of the prior art suggests or teaches a boom structure created via an additive manufacturing process.

None of the prior art suggests or teaches an extendable boom structure created with a tensioned cable.

None of the prior art suggests or teaches an extendable boom structure created with shape memory material(s).

None of the prior art suggests or teaches an extendable boom structure created with a paid-out cable, stiffened during deployment.

None of the prior art suggests or teaches an extendable boom structure created with paid-out pliable members which make stiff assembly when attached to each other during deployment.

None of the prior art suggests or teaches a free-floating telescope structure where the propulsion/generation system and imaging mirror are located at the same end of the structure and opposite the boom and/or counterweight.

### OBJECTS AND ADVANTAGES

### Large Optical Apertures Possible

In contrast to the prior art mentioned hereinabove, the present invention describes a structure which would be, while being compact at launch, when in space, create and deploy a paraboloid mirror of the size enabling imaging at significantly improved resolution. It is not inconceivable to create mirrors in space with diameters exceeding 10- or even 50 meters using present invention.

Having a large aperture (diameter) of an optical component, such as a mirror, is critical for improved imaging, since optical resolution is directly related to the size of the aperture:

$${a}_{D} = 1.22 \frac{λ}{D} \qquad ( 1 )$$

Where
α_{D} is angular resolution (smaller value is desirable)
λ is wavelength of light
D is the aperture (optical element effective diameter)

In low-, micro-, or zero-gravity environments, the size of the mirror support and its boom are limited only by structural rigidity requirements during structure's maneuvers and their ultimate strength during mirror generation maneuvers. The mirror size will also be affected by the precursor material's viscosity and surface tension.

Thus, very- to extremely-large mirrors are possible to construct in space.

### High Volumetric Storage Efficiency

The pliable mirror support in its stowed configuration does not require extensive specialized supports for protection during launch due to its compact size and weight. The mirror support and deployment structures are also effectively ‘self-deploying’, in that they do not require auxiliary mechanisms for their deployment, other than electrical current for their heating.

The resulting mirror can also be much lighter than the present ones, because it does not carry with it the deploying or assembly structures, saving on launch cost and complexity, and saving the on-board propellant for on-orbit structure/telescope maneuvering. Both the material used (for example, a photopolymer) and the volume (a thin film) of the mirror material can be orders of magnitude lighter than even the lightest present solid paraboloid space mirrors.

### Light Weight

The mirror support of instant invention comprises a thin lightweight pliable shell. In addition, due to the absence of the relatively heavy mechanical deployment mechanisms and their associated interfaces, the weight of instant mirror system is greatly reduced. The required actuating heat is generated by passing electric current directly through the support struts and support hoop. A completely passive heating and deployment of mirror support can be also achieved by exposing the mirror system elements to sunlight by appropriately maneuvering the structure. In the vacuum of space, solar heating can be considerable.

### Simplified Construction: ‘Self-Deployable’ System

The mirror system of instant invention comprises a limited number of parts. There are no separate ‘actuators’ per se, other than shape memory struts and boom actuators in some embodiments. The system elements literally deploy themselves upon application of heat, by utilizing elastic mechanical energy stored at the time of their packaging.

### Easier Actuator Redundancy Implementation

With thermal actuation of shape memory elements of instant invention replacing conventional electro-mechanical and mechanical actuators the instant system is more reliable, since the only moving parts are the system elements themselves. In addition, the shape-memory elements do not require special rotating or sliding joints.

Since it is much easier to provide redundancy to an electrically heated deployment system than to a mechanical actuators-based one, the shape-memory based mirror support system possesses enhanced redundancy of its deployment apparatus.

Also, if required, timed heater activation in very specific and precise deployment sequences is possible to minimize the risk of malfunction or mechanical interference and also to control possible recoil and vibrations.

### High Stored Mechanical Energy

The shape-memory materials used for the mirror support, struts and the boom store considerable mechanical elastic energy at the time of their packaging for stowed configuration and can generate considerable restoration forces while being heated for deployment. These significant forces would help to overcome potential adhesions, friction and snags found in space applications. This improves overall reliability of the mirror deployment and therefore, the reliability of the entire system.

### Optional Deployment by Sunlight

Since heating of objects in space by solar radiation can be considerable, the instant mirror system elements can be exposed to sunlight instead of heaters for their deployment. This also can be used as a backup procedure in case of heater malfunction.

### Optional Precursor Material Curing by Sunlight

Solar radiation in space contains large amount of UV light which can be advantageously used to crosslink the mirror photopolymer material precursor for the support stiffening, for the mirror generation itself, as well as for some boom implementations.

### In-Space Mirror Testing and Repair/Regeneration

The completed mirror can be tested by pointing it towards a star (a virtually perfect light point source) and analyzing the resulting image. If required, the mirror can be repaired/re-cast in space by repeating the casting/solidification/curing procedures.

### BRIEF DESCRIPTION OF THE DRAWINGS

FIG. 1 is a perspective view of the space-borne telescope 52 in stowed configuration.

FIG. 2 is a perspective view of the telescope 52 in partial deployment configuration 52′.

FIG. 3 is a perspective exploded view of the telescope 52 in stowed configuration.

FIG. 4 is a perspective view of telescope 52 in fully deployed configuration 52a.

FIG. 4A is a perspective view of telescope 52 in fully deployed configuration 52a illustrating mirror generation parameters

FIG. 5 is a schematic of heating mechanism for struts 160.

FIG. 6 is alternative schematic of heating mechanism for struts 160.

FIG. 7 is a perspective view of corrugated boom 120 in stowed configuration.

FIG. 8 is a cross section of corrugated boom 120 in stowed configuration.

FIG. 8A is a cross section of corrugated boom 120 in stowed configuration with schematic of its heating mechanism.

FIG. 9 is a perspective view of mirror supports 42 or 42′ in stowed configuration.

FIG. 10 is a cross section of heat pipe mirror support variant 42′.

FIG. 11 is cross-sectional view of 42 in stowed configuration showing connection of electric heating power sources.

FIG. 12 is cross-sectional view of mirror support 42 in stowed configuration showing heating sources.

FIG. 13 is a perspective view of a strut 160 in stowed configuration.

FIG. 14 is a cross-sectional view of a strut variant 164.

FIG. 15 is cross-sectional view of mirror support variant 42′ after deployment.

FIG. 16 is cross-sectional views of a solid strut 160 variants taken along the line 16-16 on FIG. 13, before and after actuation.

FIG. 17 is a cross-sectional view of a tubular strut variant 27 before and after actuation.

FIG. 18 is a cross-sectional view of a tubular strut variant 26 before and after actuation.

FIG. 19 is a perspective view of mirror precursor material container assembly 30.

FIG. 20 is a perspective view of mirror precursor material container assembly variant 30a.

FIG. 21 is a cross-sectional view taken along line 21-21 on FIG. 4A of mirror support 42 in its deployed configuration 42a showing mirror precursor material flow.

FIG. 22 is a cross-sectional view taken along line 22-22 on FIG. 4A of mirror support 42 in its deployed configuration 42a showing mirror precursor material flow.

FIG. 23 is a fragmentary cross-section view of FIGS. 21 and 22 illustrating the formation of the paraboloid shape of the mirror.

FIG. 24 is a perspective view of the deployed boom 120a being jettisoned from telescope 52a.

FIG. 25 is a perspective view of the integrated assembly 70.

FIG. 26 is a cross-section taken along the line 26-26 on FIG. 25.

FIG. 27 is a partial cross-section taken along the line 27-27 on FIG. 26.

FIG. 27A is a perspective view of the integrated assembly 72.

FIG. 28 is a cross-section taken along the line 28-28 on FIG. 27A.

FIG. 29 is a perspective view of the telescope variant 50 in its stowed configuration.

FIG. 30 is a perspective view of the telescope variant 50 in its deployed configuration 50a.

FIG. 31 is a partial perspective view of the telescope variant 50 in its deployed configuration 50a.

FIG. 32 is a perspective exploded view of the telescope variant 52 in its stowed configuration.

FIG. 33 is a perspective exploded view of the telescope variant 53 in its stowed configuration.

FIG. 34 is a perspective view of the telescope variant 53 in its deployed configuration 53a.

FIG. 35 is a partial perspective view of the telescope variant 53 in its deployed configuration 53a.

FIG. 36 is a perspective exploded view of the telescope variant 53 in its stowed configuration.

FIG. 37 is a perspective view of the telescope variant 60 in its stowed configuration.

FIG. 38 is a perspective view of the telescope variant 60 in its partially deployed configuration 60′.

FIG. 39 is a perspective view of the telescope variant 60 in its deployed configuration 60a.

FIG. 39a is a fragmentary perspective view of boom 140a of telescope variant 60.

FIG. 40 is a perspective exploded view of the telescope variant 65 in its stowed configuration.

FIG. 41 is a perspective view of the telescope variant 65 in its partially deployed configuration 65′.

FIG. 42 is a perspective view of the telescope variant 65 in its fully deployed configuration 65a.

FIG. 43 is a perspective exploded view of the telescope variant 66 in its stowed configuration.

FIG. 44 is a perspective view of the telescope variant 66 in its partially deployed configuration 66′.

FIG. 45 is a perspective view of the telescope variant 66 in its fully deployed configuration 66a.

FIG. 46 is a perspective exploded view of the telescope variant 67 in its stowed configuration.

FIG. 47 is a perspective view of the telescope variant 67 in its partially deployed configuration 67′.

FIG. 48 is a perspective view of the telescope variant 67 in its fully deployed configuration 67a.

FIG. 49 is a perspective exploded view of the telescope variant 68 in its stowed configuration.

FIG. 50 is a perspective exploded view of the telescope variant 69 in its stowed configuration.

FIG. 51 is a perspective view of the deployed pliable mirror support 450a supported by deployed support hoop 400a.

FIG. 52 is a perspective view of the deployed pliable mirror support 450a supported by deployed support hoop 420a.

FIG. 53 is a perspective view of the shape memory coiled support hoop 400 in stowed configuration connected to the heating electrical source 220.

FIG. 54 is a perspective view of the shape memory folded support hoop 420 in stowed configuration connected to the heating electrical source 220.

FIG. 55 is a perspective view of the super-elastic variant 401 of the coiled support hoop constrained within meltable constraining sleeve 405.

FIG. 56 is a perspective view of the super-elastic variant 421 of folded support hoop constrained by meltable cord 413.

FIG. 57 is a perspective view of the telescope variant 69 fully deployed.

FIG. 58 is a partial perspective view of the telescope variant 52b with reaction wheels 500 positioning system in deployed configuration.

FIG. 59 is a perspective view of the telescope variant 64 in its stowed configuration.

FIG. 60 is a partial exploded view of the cable tractor 138 of the telescope variant 64.

FIG. 61 is a perspective view of the telescope variant 64 fully deployed.

FIG. 62 is a perspective view of the cable 195 deployment assembly.

FIG. 63 is a partial perspective view of the cable 195 deployment assembly showing coating and curing system.

FIG. 64 is a partial cross section view of the cable coating and curing system taken along the line 64-64 on FIG. 63.

FIG. 65 is a partial cross section view of the cable 195 coating curing system 470 taken along the line 65,66-65,66 on FIG. 62.

FIG. 66 is a partial cross section view of the cable 195 coating curing system variant 470a taken along the line 65,66-65,66 on FIG. 62.

FIG. 67 is a perspective view of the assembly for deployment of boom 198.

FIG. 68 is a partial perspective view of the boom members 205 in their deployed configuration 205a.

FIG. 69 is a perspective view of the boom binder/snubber disk 302.

FIG. 70 is a flowchart 600 of corrugated mirror support 40 or 42 deployment Sequence A.

FIG. 71 is a flowchart 600a of alternative corrugated mirror support 40 or 42 deployment Sequence B.

FIG. 72 is a flowchart 700 of telescope deployment and mirror generation Sequence 1.

FIG. 73 is a flowchart 900 of mirror generation Sequence 2.

FIG. 74 is a flowchart 900a of mirror generation Sequence 2A.

FIG. 75 is a flowchart 800 of mirror support hoop 400 or 420 deployment sequence.

FIG. 76 is a flowchart 800a of mirror support hoop 401 or 421 deployment sequence.

### DESCRIPTION OF THE EMBODIMENTS

In the foregoing description like components are labeled by the like numerals.

It should be noted that the collective designation ‘telescope’ refers not only to telescopes in the conventional sense, but space-borne structures utilizing imaging systems.

There are two fundamental telescope designs presently disclosed, namely, 1. a direct imaging type, and 2. a Cassegrain-type with a folded light path.

The direct-imaging system uses the primary mirror 40a and imager system 24 located in integrated assembly 70.

The Cassegrain telescope design uses two mirrors: primary mirror 42a and secondary mirror 25 located in integrated assembly 72. Primary mirror 42a has aperture 44′ in its center to permit light reflected by secondary mirror 25 to reach imager system 80 located in main system enclosure 170.

There are two major types of the deployable mirror support disclosed: rigid supports 40 and 42 which are both based on shape memory materials, and pliable support 450 stretched for deployment by shape memory support hoops 400 or 420, or their respective superelastic variants 401 and 421.

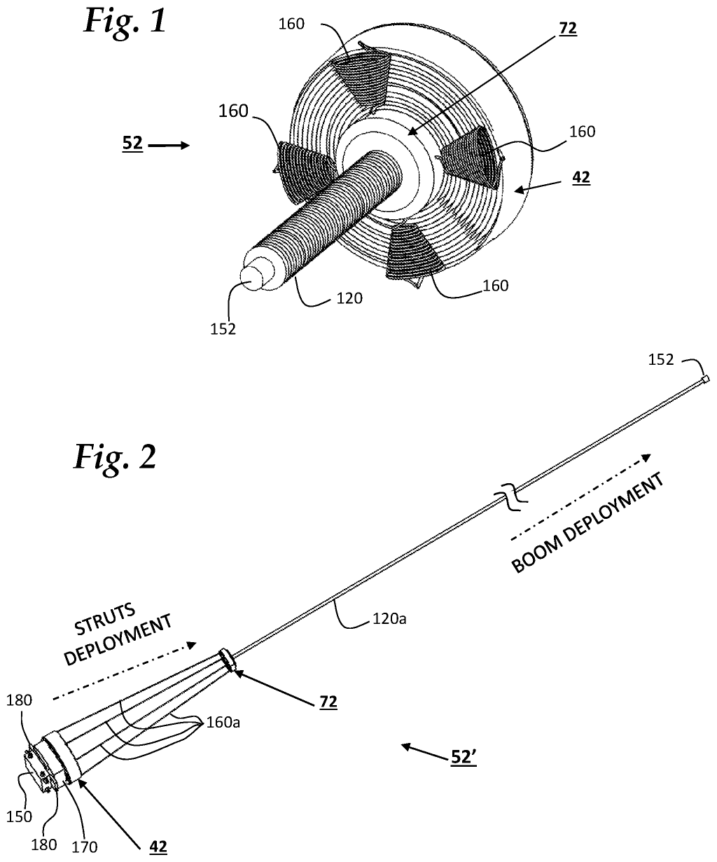

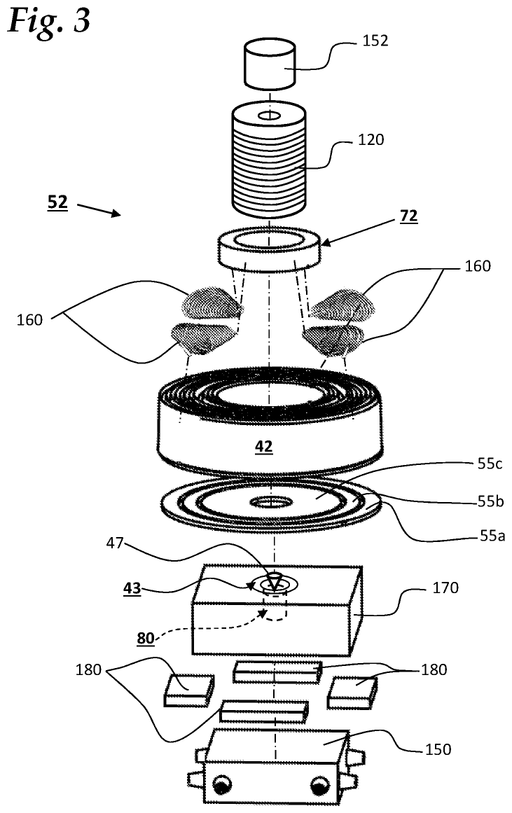

Referring to FIGS. 1 and 3 Cassegrain-type telescope 52 in its stowed configuration comprises telescope primary mirror support 42, corrugated shape memory boom 120 with counterweigh 152, telescope main system enclosure 170 containing imager system 80, control and communications systems (not shown), mirror precursor material storage and dispensing system 30c (not shown). Light baffle 47 prevents stray light from entering imager system 80.

Mirror support 42 is further connected to integrated assembly 72 by deployable struts 160, all shown in their respective stowed configurations. Integrated assembly 72 contains, in addition to the secondary mirror 25 (not shown), UV exposure sources 90 (not shown) and reflective coating deposition sources 98 (not shown).

Additionally, telescope 52 comprises heating elements 55a, 55b and 55c used for deployment of primary mirror support 42, solar panels 180 (shown in their stowed configuration) and propulsion unit 150.

FIG. 2 shows telescope 52 in its intermediate deployment configuration 52′, with corrugated boom 120 have transitioned to its deployed configuration 120a upon being heated, and struts 160 assuming their respective extended configuration 160a also upon being heated. Primary mirror support 42 has not been deployed yet, and neither have been solar panels 180.

FIGS. 7, 8 and 8A show corrugated boom 120 construction comprising annular folds 103. Boom 120 is extended into its deployed configuration 120a by being heated by electric current passing through it by source 210, as shown in FIG. 8A.

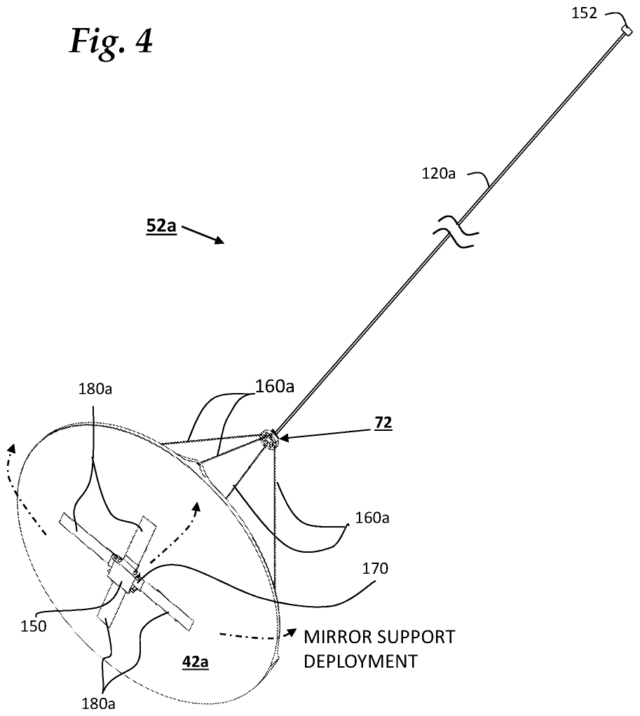

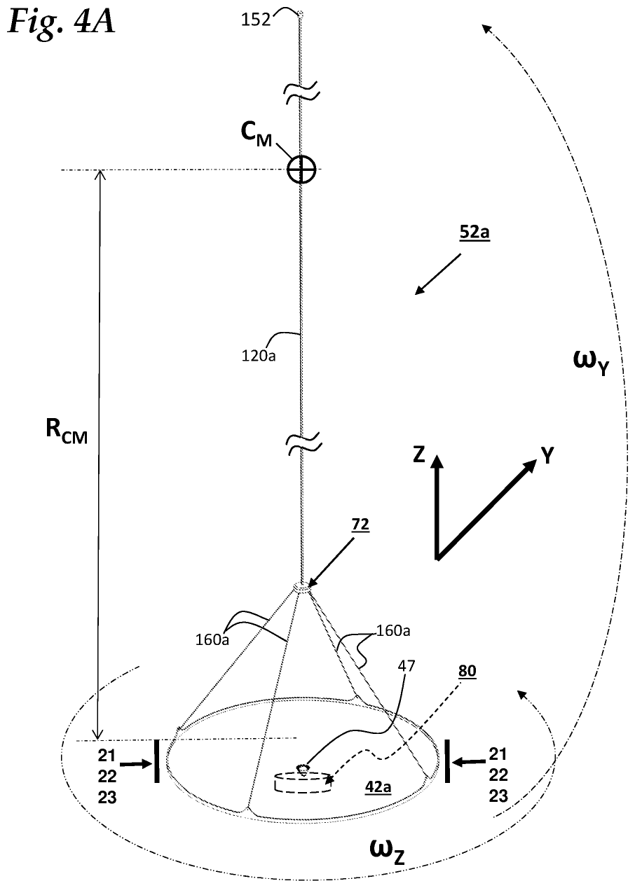

FIG. 4 shows telescope 52 in its deployed configuration 52a. Mirror support 42 has assumed its deployed shape 42a upon being heated, solar panels 180 unfolded to their opened configuration 180a, and struts 160 are in their deployed configuration 160a to position integrated assembly 72 at a working distance to mirror support 42a and imager system 80.

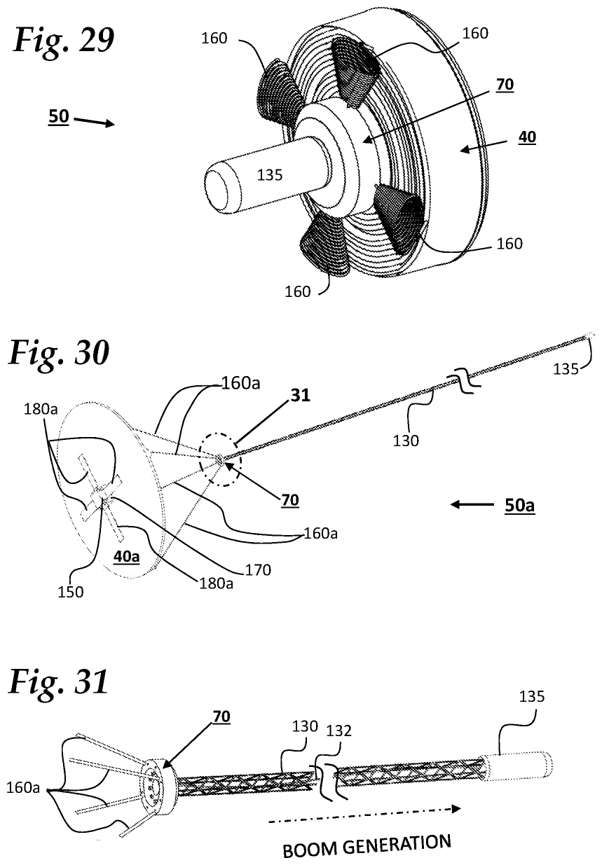

An alternate telescope embodiment 50 is shown on FIG. 29 in its stowed configuration. It comprises primary mirror support 40 in its stowed configuration, integrated assembly 70 and boom generator 135. Mirror support 40 is further connected to integrated assembly 70 by deployable struts 160, all shown in their respective stowed configuration.

FIG. 30 shows direct-imaging type telescope 50 in its deployed configuration 50a. Mirror support 40 has assumed its deployed shape 40a, solar panels 180 unfolded to their opened configuration 180a, and struts 160 extended into their deployed configuration 160a to position integrated assembly 70 at a working distance to mirror support 40a.

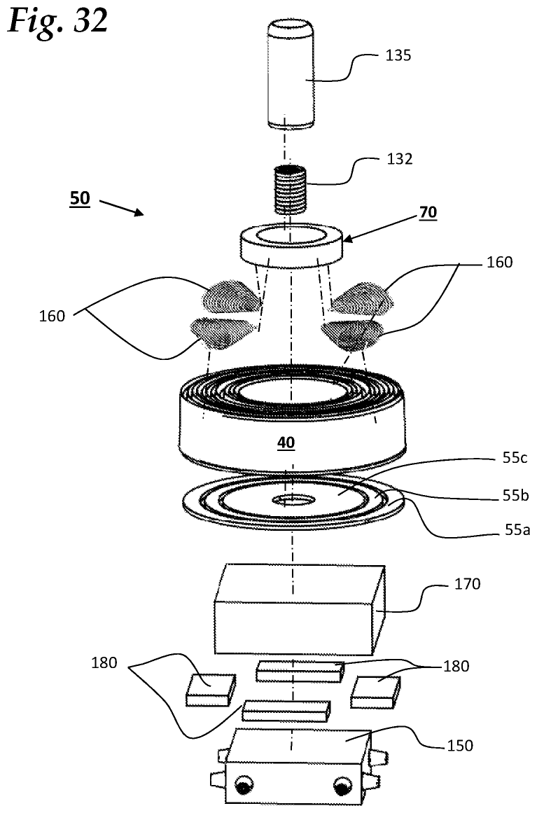

Referring to FIG. 32 telescope 50 further comprises boom generator umbilical 132 and optional heating elements 55a, 55b and 55c used for deployment of primary mirror support 40, telescope main system enclosure 170 containing control and communications systems (not shown), mirror precursor material storage and dispensing system 30a or 30b (not shown), solar panels 180 (shown in their stowed configuration) and propulsion unit 150.

On FIG. 31 boom 130 is being formed by generator 135 which is positioned on the distal end of boom 130 and travels outwardly as it generates boom 130. After boom 130 is completed generator 135 serves as a counterweight. Generator 135 is connected to boom 130 material precursor supply and power source located in system enclosure 170 via umbilical 132 which extends through integrated assembly 70 along struts 160 and ultimately to boom material storage container (not shown) inside system enclosure 170.

Alternatively, boom generator 135 can contain its own supply of boom material precursor and umbilical 132 would be used only to supply power.

Still alternatively, boom generator 135 can also contain its own power source in addition to the material precursor supply, in which case umbilical 132 is not required.

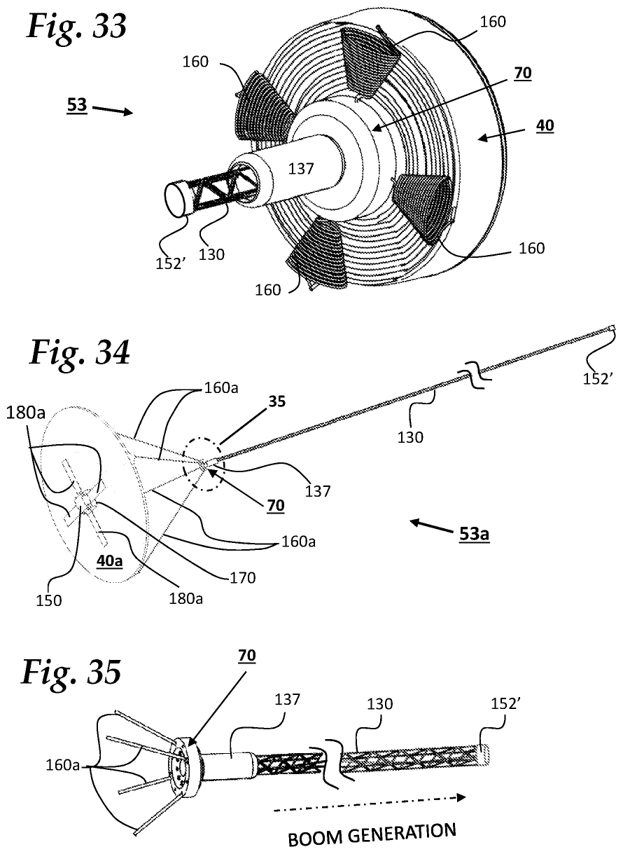

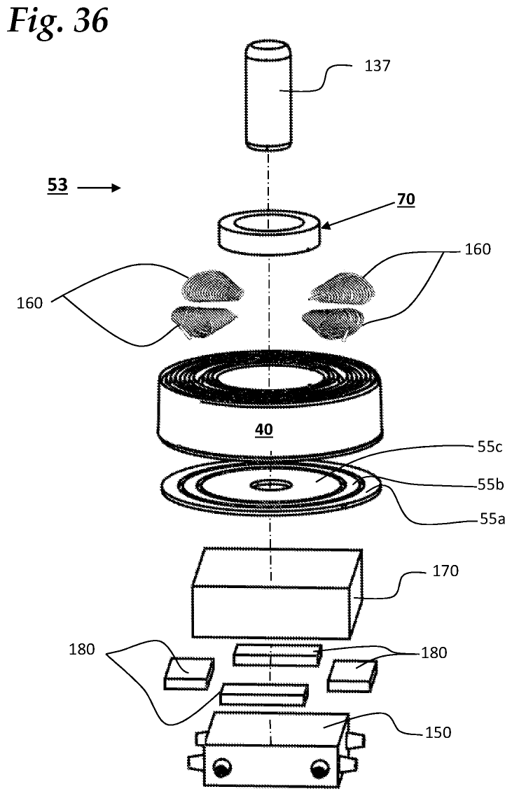

Referring to FIGS. 33 and 36 an alternate telescope embodiment 53 is shown in its stowed configuration. It is virtually identical to embodiment 50 with its elements present and labeled identically to it, with the exception of boom generator 137 being stationary and attached to integrated assembly 70, and the absence of the boom generator umbilical. For illustration purposes boom 130 is shown being formed and emerging from generator 137 being preceded by counterweight 152′ located on its distal end.

FIG. 34 shows telescope 53 in its fully deployed configuration 53a. Mirror support 40 has assumed its deployed configuration 40a, solar panels 180 opened to their deployed configuration 180a, and struts 160 extended into their deployed configuration 160a to position integrated assembly 70 at its working distance to mirror support 40a.

On FIG. 35 boom 130 is being formed by stationary generator 137. Generator 137 may contain boom precursor material within or be connected to material storage container (not shown) in system enclosure 170. Fabrication of boom 130 starts with generating counterweight 152′. A material different from the rest of the boom 130 (for example, having higher density and/or dense additives) can be used for counterweight 152′.

Alternatively, counterweight 152′ can be ready-made and pre-installed in generator 137 to interface with boom 130 being subsequently formed.

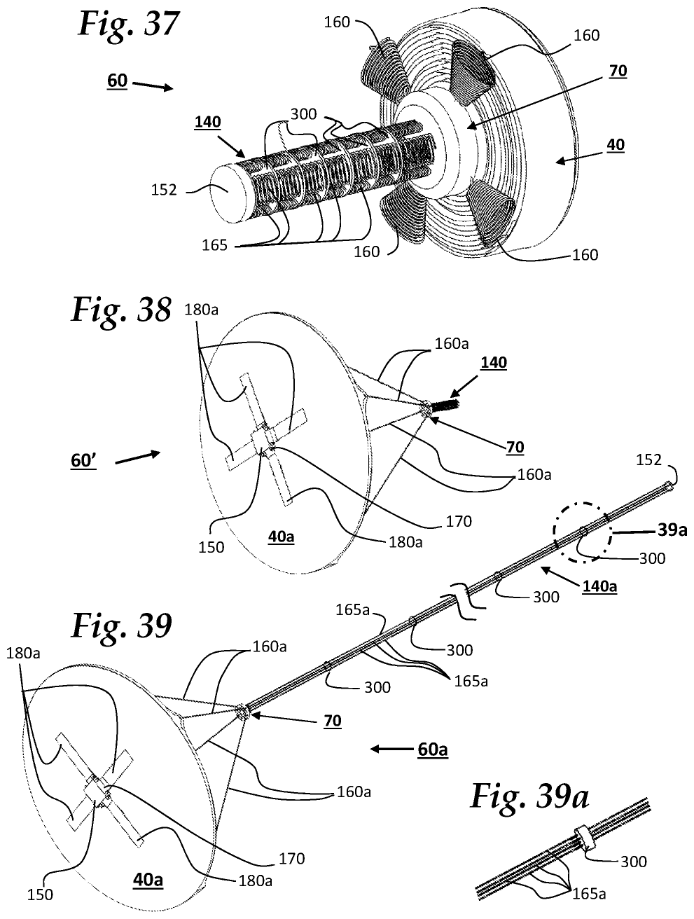

Referring to FIG. 37 an alternate telescope embodiment 60 is shown in its stowed configuration. It shares common construction and elements with embodiments 52 and 53 with the exception of deployable boom assembly 140.

Deployable boom assembly 140 comprises several deployable elongated elements 165 coiled for their stowed configuration and periodically interconnected by snubber/stiffener elements 300. At its distal end boom assembly 140 contains a counterweight 152.

FIG. 38 shows an intermediate deployment stage of telescope 60′. Mirror support 40 has assumed its deployed shape 40a, solar panels 180 unfolded to their opened configuration 180a, and struts 160 extended into their deployed configuration 160a to position integrated assembly 70 at its working distance to mirror support 40a. Boom 140 is still in its stowed configuration.

FIG. 39 shows telescope 60 in its fully deployed configuration 60a. From its intermediate deployment configuration boom assembly 140 assumed its deployed configuration 140a via its coiled elements 165 being heated uncoiling and straightening into their deployed configuration 165a. Boom elements 165a are held together at intervals by snubber/stiffening elements 300. Elements 300, in addition to providing stiffness to the assembly can contain damping features which would eliminate or diminish vibrations of the boom during its deployment and/or during telescope maneuvers. FIG. 39a further details relationship between deployed elements 165a and elements 300.

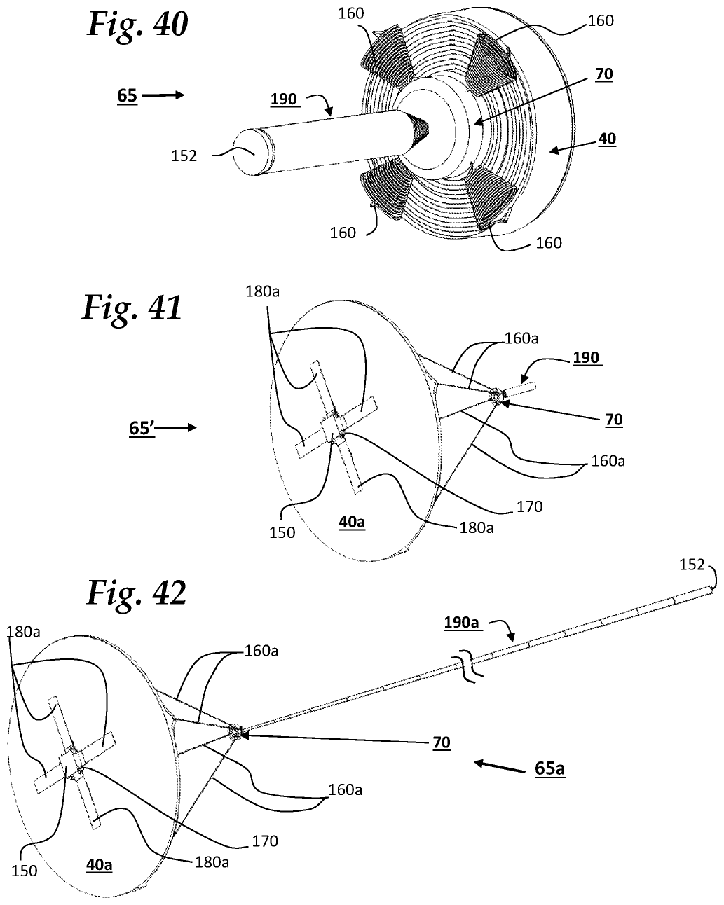

Referring to FIG. 40 an alternate telescope embodiment 65 is shown in its stowed configuration. It shares common construction and elements with embodiments 52, 53 and 60, with the exception of its deployable boom assembly 190.

Deployable boom assembly 190 comprises a plurality of nested telescopic elements extendable into a full-length boom by the action of compressed gas, chemically/pyrotechnically generated gas, thermally generated steam or due to action of shape-memory coiled actuator(s) contained within (not shown) which straighten upon being heated. At its distal end boom assembly 190 contains a counterweight 152.

FIG. 41 shows an intermediate deployment stage of telescope 65′. Mirror support 40 has assumed its deployed shape 40a, solar panels 180 unfolded to their opened configuration 180a, and struts 160 extended into their deployed configuration 160a to position integrated assembly 70 at its working distance to mirror support 40a.

FIG. 42 shows telescope 65 in its fully deployed configuration 65a. Boom assembly 190 assumed its deployed configuration 190a by extending all of its telescopic sections.

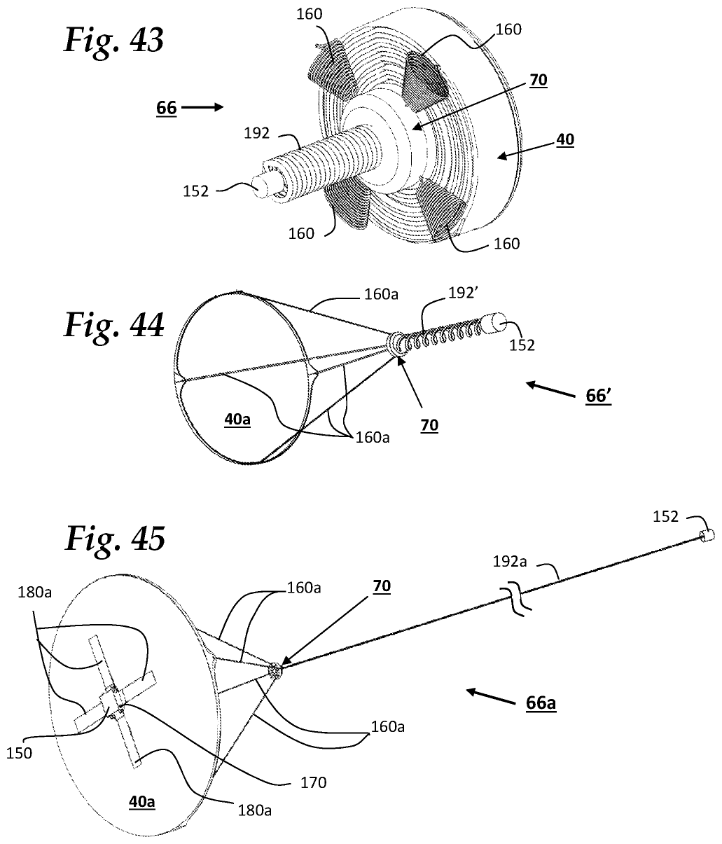

Referring to FIG. 43 an alternate telescope embodiment 66 is shown in its stowed configuration. It shares common construction and all elements with embodiments 52, 53, 60 and 65 with the exception of deployable boom 192.

Deployable boom 192 comprises a coiled element preferably of shape memory material extendable into a full-length boom by application of heat. At its distal end boom 192 contains a counterweight 152. Alternatively, boom 190 can be is made out of a superelastic material and held in stowed configuration by removable/frangible/meltable constraining element(s) (not shown).

FIG. 44 shows an intermediate deployment stage of telescope 66′. Mirror support 40 has assumed its deployed shape 40a, and struts 160 extended into their deployed configuration 160a to position integrated assembly 70 at its working distance to primary mirror support 40a. Boom 192 is shown in its intermediate configuration 192′ in the process of deployment.

FIG. 45 shows telescope 66 in its fully deployed configuration 66a. Boom 190 assumes its deployed configuration 192a by fully uncoiling upon being heated, or spontaneously upon release from constraining element(s) if it is made out of a superelastic material.

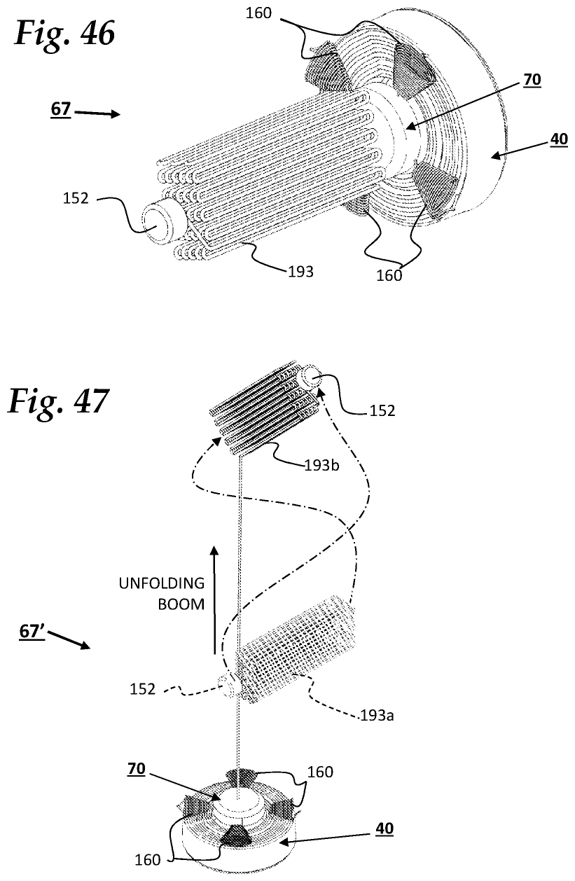

Referring to FIG. 46 an alternate telescope embodiment 67 is shown in its stowed configuration. It shares common construction and elements with embodiments 52, 53, 60, 65, 66, with the exception of its deployable boom 193.

Boom 193 comprises a folded shape memory rod which unfolds into a full-length elongated boom upon application of heat. At its distal end boom 193 contains a counterweight 152. Alternatively, boom 193 can be made from straight sections made with conventional materials, such as metal or fiber composite connected by shape memory or superelastic hinge elements (not shown). Alternatively, the hinges between straight sections can be spring-loaded.

FIG. 47 shows an intermediate deployment stage of telescope 67′. Mirror support 40 has not been deployed yet, and neither have struts 160. Upon application of heat (in case boom 193 is made with or contains shape memory deployment elements), boom 193 unfolds through intermediate configurations 193a and 193b. If boom 193 is made with superelastic/sprung hinges, it deploys automatically by removing mechanical constraints attached to it for stowage.

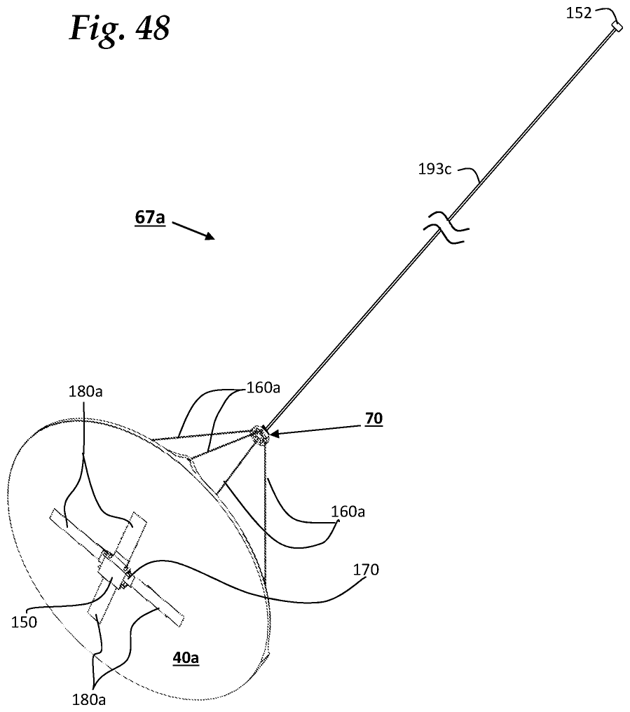

FIG. 48 shows telescope 67 in its fully deployed configuration 67a. Boom 193 assumes its fully deployed configuration 193c by unfolding all its components.

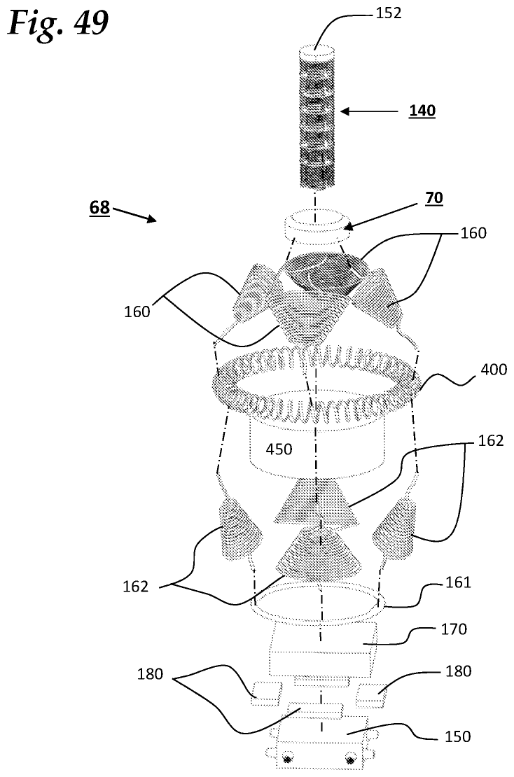

FIGS. 49, 51, 53 and 55 refer to telescope embodiment an alternate telescope embodiment 68 which utilizes pliable mirror support 450.

Referring to FIG. 49 an alternate telescope embodiment 68 is shown in its stowed configuration. It features deployable pliable primary mirror support 450 to be stretched and supported by deployable coiled support hoop 400 to which it is attached. Support hoop 400 is attached to support ring 161 by deployable struts 162. On its opposite side hoop 400 is attached to integrated assembly 70 by deployable struts 160. This telescope embodiment utilizes boom assembly 140 and counterweight 152 described earlier, but can utilize a boom of any construction described in instant application. Mirror material precursor storage and dispensing system variants 30 through 30c are not shown for clarity.

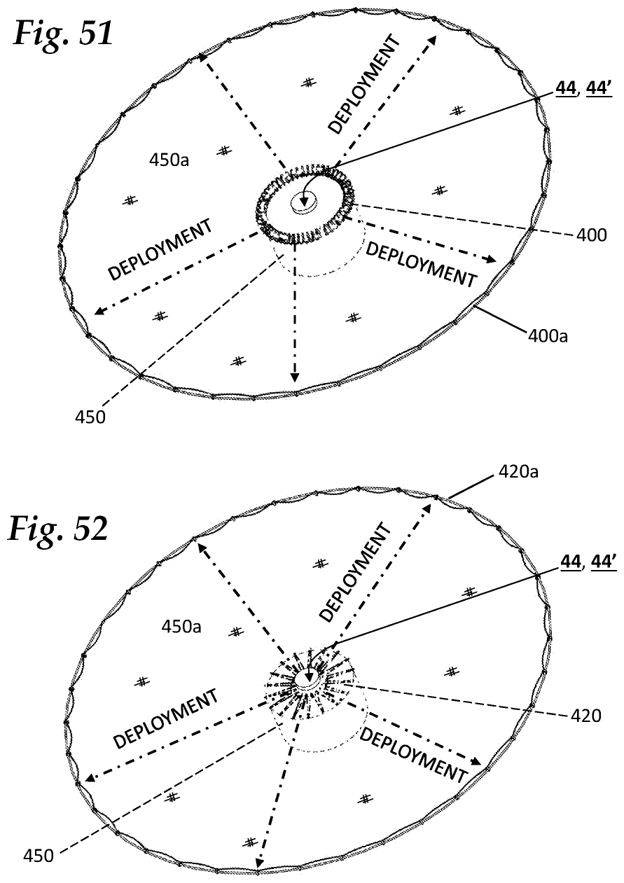

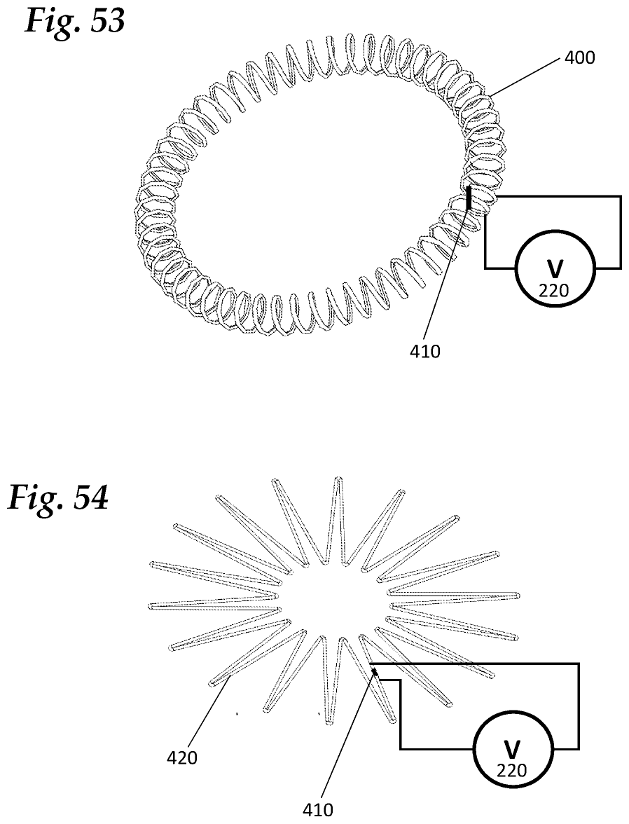

FIG. 51 depicts deployment of pliable support 450 into its deployed configuration 450a by being stretched by coiled support hoop 400 assuming its deployed circular configuration 400a by being heated by electric current supplied by source 220 shown on FIG. 53. Electrical insulator 410 is incorporated into the coil 400 to provide single path for the electric current supplied by source 220.

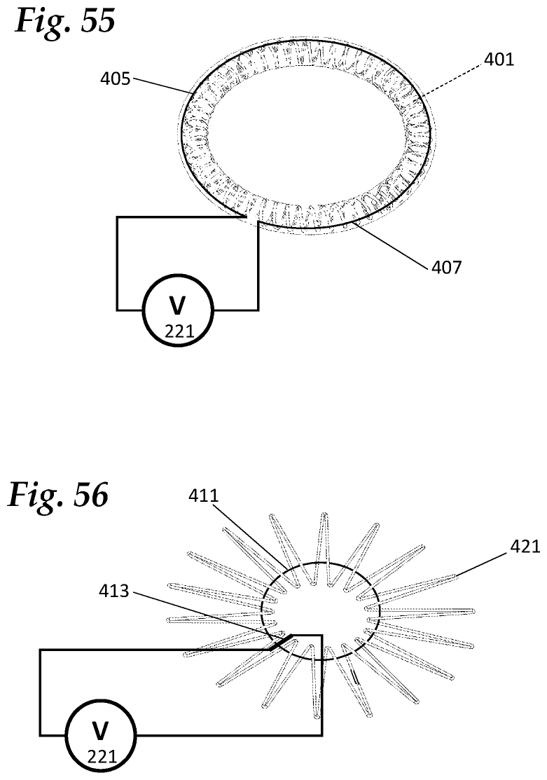

FIG. 55 shows alternative coiled support hoop 401 made with superelastic material. It is held in compressed coiled stowed shape by meltable sleeve 405. Sleeve 405 also contains an electrically heated thermal cutter 407 connected to source 221. When electrical current from source 221 is applied to cutter 407 it heats up and melts and cuts through sleeve 405 releasing coiled hoop 401 which assumes its deployed circular configuration virtually identical to 400a.

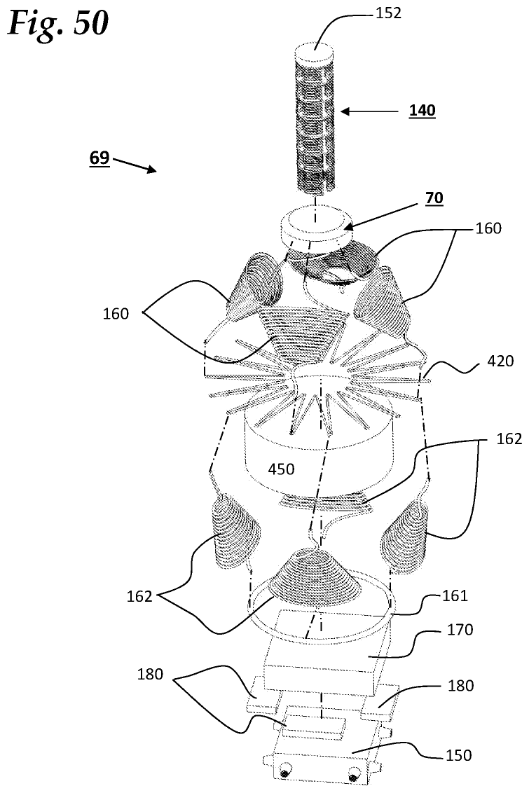

FIGS. 50, 52, 54, 56 and 57 father detail telescope embodiment 69 which utilizes pliable mirror support 450 supported by folded hoop 420.

Referring to FIG. 50 an alternate telescope embodiment 69 is shown in its stowed configuration. It features deployable pliable primary mirror support 450 to be stretched and supported by deployable folded support hoop 420 to which it is attached. Support hoop 420 in turn is attached to support ring 161 by deployable struts 162. On its opposite side support hoop 400 is attached to integrated assembly 70 by deployable struts 160. This telescope embodiment also utilizes boom assembly 140, but can utilize a boom of any construction described earlier. Mirror material precursor storage and dispensing system variants 30 through 30c are not shown for clarity.

FIG. 52 depicts deployment of pliable support 450 into its deployed configuration 450a by being stretched by folded support hoop 420 assuming its deployed circular configuration 420a by being heated by electric current supplied by source 220 shown on FIG. 54. Electrical insulator 410 is incorporated into the coil 420 to provide single path for the electric current supplied by source 220.

FIG. 56 shows alternative folded support hoop 421 made with superelastic material. It is held in stressed stowed shape by meltable ring 411. Ring 411 is in thermal contact with an electrically heated thermal cutter 413 connected to source 221. When electrical current from source 221 is applied to cutter 413 it heats up and melts and cuts through ring 411 releasing hoop 421 which assumes its deployed circular configuration virtually identical to 420a. This type of thermal release mechanism of sprung elements is well known in the art.

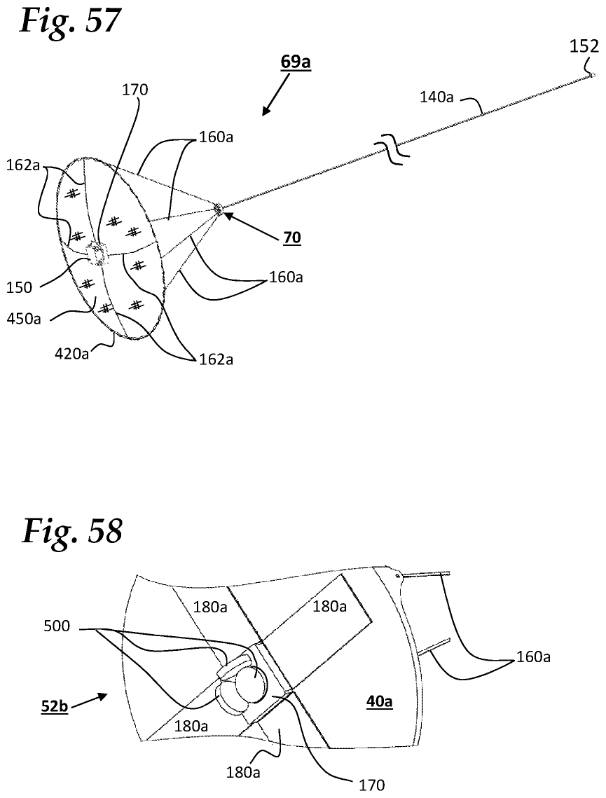

FIG. 57 shows telescope 69 in its fully deployed configuration 69a (solar panels 180 not shown for clarity). Lower struts 162 extend into their deployed shape 162a and support deployed support hoop 420a which in turn supports and stretches deployed pliable mirror support 450a. Struts 160 extend into their deployed configuration 160a and position integrated assembly 70 at its working distance to the primary mirror support 450a.

Telescope 68 comprising coiled support hoop 400 instead of folded hoop 420 would have a similar deployed configuration (not shown).

FIG. 58 shows a part of telescope 52b variant which is virtually identical to telescope 52a with the exception of reaction wheels 500 used instead of propulsion unit 150.

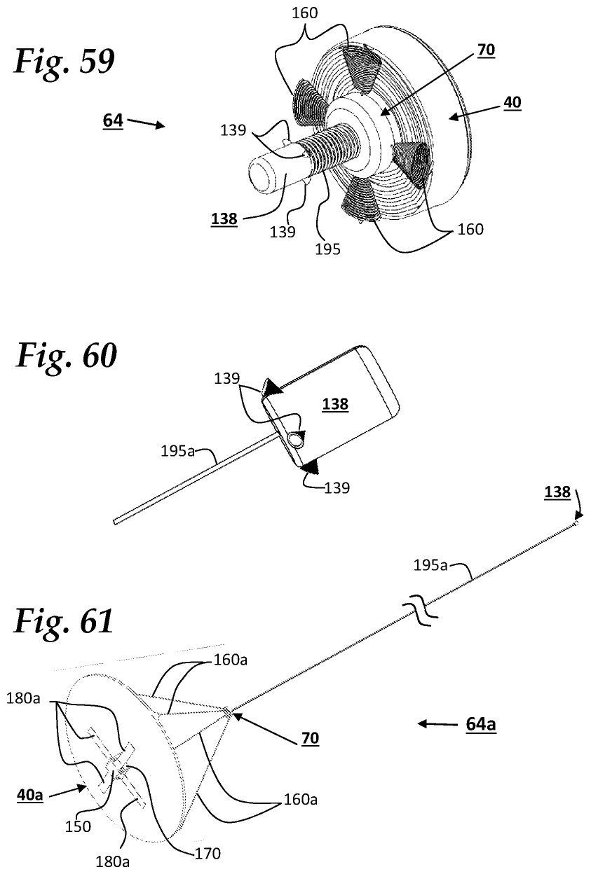

Referring to FIG. 59 an alternate telescope embodiment 64 is shown in its stowed configuration. It has integrated system 70 similar to 52, 53, 60, 65, 66, 67, 68 and 69 with the exception of its deployable boom 195. Boom 195 comprises a cable or a hollow umbilical compactly coiled in its stowed configuration.

Tractor 138 is launched outwardly from telescope 64, extending boom 195 into its deployed configuration 195a and subsequently maintaining it under tension and assisting in the rotation of the telescope for its primary mirror generation by serving as a counterbalance.

As shown on FIG. 60 tractor 138 comprises independently controlled nozzles 139 to effect its required maneuvers.

Tractor 138 can contain its own propellant, or can be fed with gaseous, steam or liquid propellant from main system enclosure 170 or integrated assembly 70 through boom 195a.

Alternatively, boom 195a can have more than one lumen and each lumen can be connected to its respective nozzle to impart the required momentum/tension vector to tractor 138.

Alternatively, tractor 138 can have remotely controlled valves operated via boom 195a by a controller located in main system enclosure 170 or being a part of the overall telescope control system.

Still alternatively, tractor 138 can have its own controller to effect maneuvering autonomously or semi-autonomously by controlled activation of nozzles 139. It can also be wirelessly controlled from system controller (not shown) located in system enclosure 170.

A pressurized propellant could be also delivered through boom 195a and then via the valves to nozzles 139. In case a liquid propellant is used, it can be expelled directly or made to decompose and generate propulsion gas or gasses. Two- or several component propellant (commonly known as hypergolic) can be mixed at the nozzles 139 to generate exhaust products.

Still alternatively, a steam generated by heating water can also be used as a propellant.

Alternatively, ion-or electro-hydrodynamic engines can be substituted for nozzles 139. These propulsion techniques and their respective propellants are well known in the art.

FIG. 61 shows telescope 64 in its fully deployed configuration 64a.

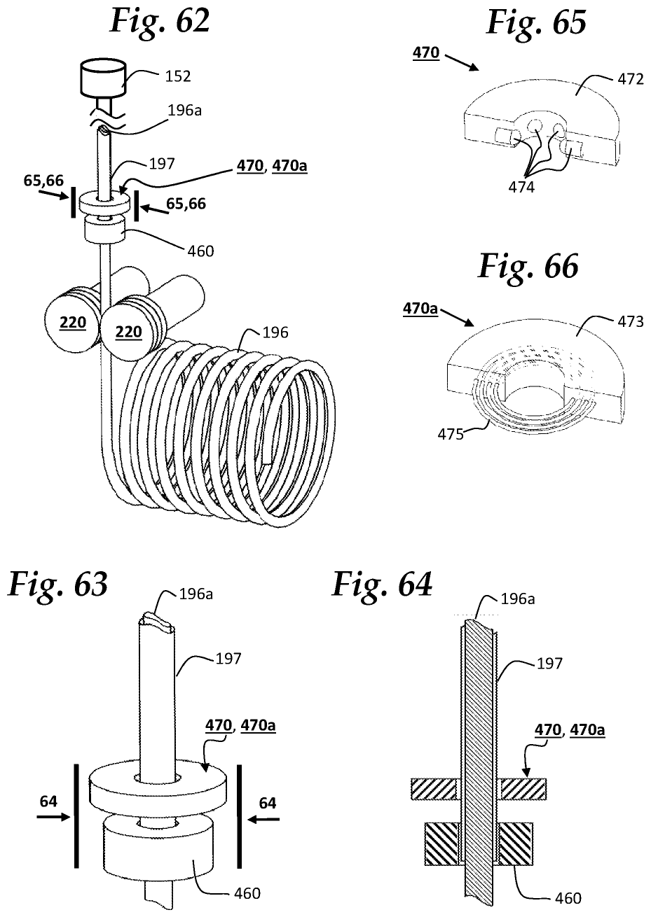

As shown on FIGS. 62 through 64 a boom variant 196 comprising stiffened cable is paid out for deployment from its stowed coiled configuration by payout wheel assemblies 220. As boom 196 is paid out by wheels 220 it passes through coater 460 where it is coated or impregnated with liquid stiffener material which is solidified by itself (in case of two parts epoxies, thermoplastics or low melting metals or alloys being used) or made to transform into rigid coating 197 in curing assembly 470 or 470a. As it emerges from curing assembly 470 or 470a, cable 196 assumes its rigid boom shape 196a.

Depending on the stiffener material used, curing assembly can be implemented for UV-or thermal curing as shown on FIGS. 65 and 66.

If the stiffener material is a UV-curable epoxy, curing assembly 470 is made to contain one or more UV sources 474 located in housing 472.

In case thermoplastics or low melting metals or solders are being used for stiffener, curing assembly variant 470a contains an electro-magnetic induction coil 485 located in housing 473.

Alternatively, depending on the type of stiffener precursor materials used, infrared (‘IR’) or microwave heating sources can be employed.

At its distal end boom 196a contains counterweight 152 to aid in telescope spinning maneuvers.

Alternatively, cable 196 can be pre-impregnated with stiffener material precursor prior to launch, such as a thermally- or UV-curable epoxy or low melting metal or alloy powder, thus removing the need for a coater.

The stiffener would be cured with curing assembly 470 or 470a, again, depending on the impregnating stiffening material used.

Optionally cable 196 can be over-coated with energy absorbing material or materials to dampen oscillations arising from maneuvers during telescope mirror's forming or aiming operations.

Additionally, the outer layer of cable 196 can be made of- or contain piezo-electric energy dissipating fibers or devices. These vibration energy absorbing techniques are known in their respective arts.

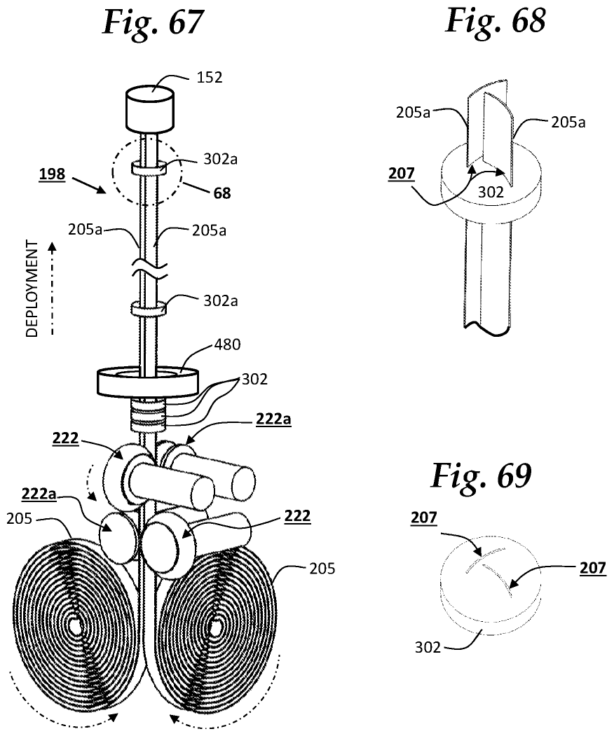

Referring to FIG. 67 an alternate deployable boom variant 198 comprising members 205 is shown. Each member 205 comprises an elongated strip of elastically compliant material having a curved profile in cross section, similar to common coiled tape measures. This construction imparts stiffness to the strip when it is straightened while allowing it to be wound into a coil for stowing. Two boom members 205 are simultaneously spooled off by complementary de-spooling assemblies 222-222a and are brought together at right angle, thus ensuring their rigidity in transverse direction.

De-spooling assemblies 222-222a comprise driven rollers with their associated drives. Rollers of de-spooling assemblies 222-222a have complementary concave-convex cross sections which match cross section profiles of 205 members. As members 205 emerge from de-spoolers 222-222a, they assume their deployed straight shapes 205a and pass through binder/snubber disks 302 via apertures 207 as shown on FIG. 68.

Each disk 302 contains binding agent (not shown) inside its apertures 207 which binds it to members 205a when disk 302 is brought inside curing/heating assembly 480 by de-spooled members 205a and becomes permanently attached to them as 302a.

In addition to its primary function of binding together members 205a disk 302 can act as a snubber to reduce/eliminate any vibrations of boom 198 encounter during its deployment or primary mirror forming maneuvers. For this function, the binding agent used to attach disk 302 to members 205a can be a viscoelastic polymer, or the disk itself can be made to contain piezo-electric elements which would convert mechanical vibrations into electricity and then dissipate it.

Alternatively, binding agent can be dispensed before disc 302 enters assembly 480. Binding agent can comprise thermoplastic compound, UV-curable epoxy or low melting metal or alloy. By cycling operation of assembly 480 and coordinating it with operation of de-spoolers 222-222a, and disk 302 releasing mechanism (not shown), attached disks 302a are positioned along members 205a at controlled intervals along their length.

Curing/heating assembly 480 is equivalent to curing assembly 470 or 470a in its construction, which would depend on the binder agent, and material of 205 members and 302 disks.

Alternatively disks 302 can be made to be mechanically attached onto members 205a, for example by snapping them via a spring-loaded latching mechanism or an elastomeric insert. Disc securing features, such as depressions or notches can be incorporated into members 205 for this purpose at regular intervals and disks 302 can be made to have features interfacing with the corresponding locating/securing features of members 205.

Alternatively, depending on the materials utilized for disks 302 and members 205, disks 302 can be welded onto members 205 via arc or spot welding. The resulting boom comprising crossed members 205a and disks 302a is rigid in three dimensions.

Attached disks 302a, in addition to providing stiffness to the assembly can contain damping features which would eliminate or diminish vibrations of the boom 198 during its deployment and/or telescope maneuvers.

Still alternatively, two or more members 205 can be welded or glued together as they are de-spooled, either in a continuous seam or intermittently along their deployed length 205a.

The resulting boom comprising welded or glued crossed members 205a is rigid in three dimensions.

At its distal end boom 198 contains counterweight 152 to aid in telescope spinning maneuvers.

Shape-memory materials used in the instant mirror support construction may include shape-memory alloys (‘SMAs’) or shape-memory polymers (‘SMPs’).

Shape-memory alloys comprise numerous alloys such as AgCd, AuCd, cobalt-, copper-, iron-, nickel- and titanium-based, with most well-known and used being Cu—Al—Ni and Ni—Ti alloys (the latter known as ‘nitinols’).

Shape-memory polymers comprise linear block polymers such as polyurethanes, polyurethanes with ionic or mesogenic components made by prepolymer method, block copolymer of polyethylene terephthalate (PET) and polyethyleneoxide (PEO), block copolymers containing polystyrene and poly(1,4-butadiene), and an ABA triblock copolymer made from poly(2-methyl-2-oxazoline) and polytetrahydrofuran.

Also, cross-linked PEO-PET block copolymers and PEEK can be used as shape-memory elements of instant invention.

Some of these SMPs can be made to contain carbon which makes them electrically conductive. This conductivity can be advantageous for their direct heating with electrical current of the mirror support and boom made from them.

Superelastic materials used in some of the telescope embodiments may be NiTi alloys, graphenes, thermoplastic elastomeric materials (known as ‘TPEs’ in the art) and such.

### TELESCOPE DEPLOYMENT AND OPERATION

The operation of the telescope is illustrated below primarily via examples of its 50a (direct imaging type) and 52a (Cassegrain type) variants. Alternative telescope variants follow similar procedures, unless described previously.

### 1. Struts Deployment

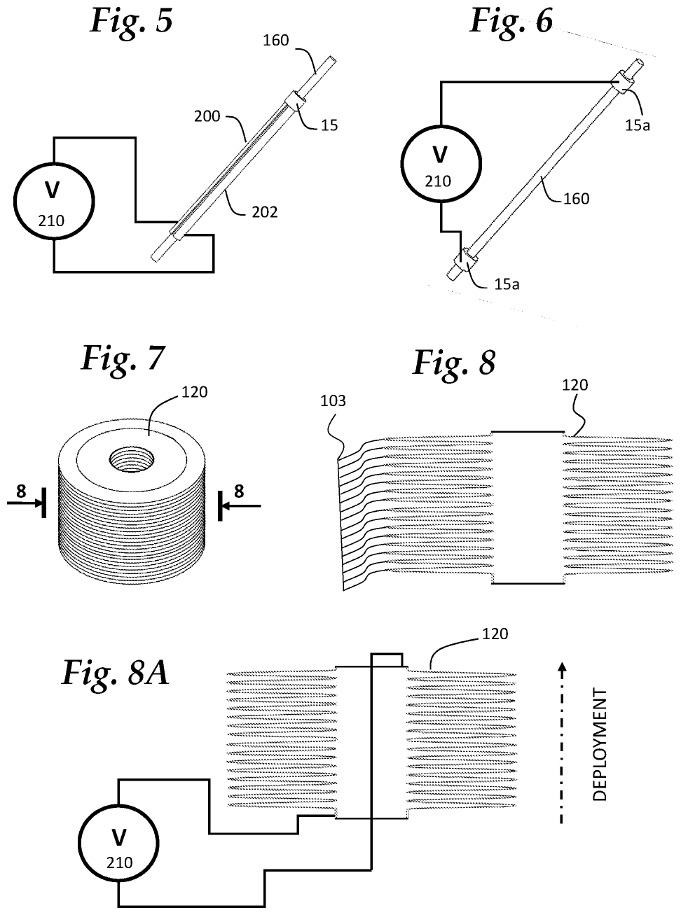

Referring to FIG. 2 as a typical example, struts 160 extend to their deployed configuration 160a by application of heat either externally or direct heating by electrical current as shown on FIGS. 5 and 6.

On FIG. 5 heat is applied to strut 160 by electric current from source 210 which travels through heater 200, then through contact 15 and returns to source 210 via heater 202. Electric current flowing through heaters 200 and 202 heats them, and they in turn heat strut 160.

An alternate heating mechanism of struts 160 is shown on FIG. 6. Electric current from source 210 proceeds through contact 15a, through strut 160 itself and through second contact 15a back to source 210, in the process heating strut 160.

Shape memory materials preferably utilized for struts' 160 construction, particularly metallic Ni-based alloys are advantageously suited for direct heating by electric current as they possess high electrical resistivity.

### 2. Boom Generation or Deployment

An extendable boom is used as a counterweight for the telescope during its rotation. There are several embodiments of the boom, utilizing divers technologies.

To provide large radius of rotation to the telescope which influences the final shape of the formed mirror, and decrease its required rotational speeds and associated with it stresses on system components, the boom is made very long.

It is also made very slender, in order not to obscure the field of view of the mirror.

The cross section of the boom is preferably smaller than the diameter of the integrated assembly 70 or 72, as to minimize its obscuration of the object of interest.

The boom can be left in place after mirror generation, or it can be jettisoned after the mirror is made, as shown on FIG. 24.

As an example of deployment of shape memory-based boom, referring to FIG. 2, corrugated boom 120 is deployed to its configuration 120a by applying electric current through it from supply 210 as shown on FIG. 8A which heats it up and causes it to assume its deployed configuration.

Alternatively, boom 130 for example, can be 3-D printed.

Alternate boom configurations' deployment and/or generation has been described previously.

### 3. Mirror Support Deployment

3a. Rigid Mirror Support 40 or 42 Deployment

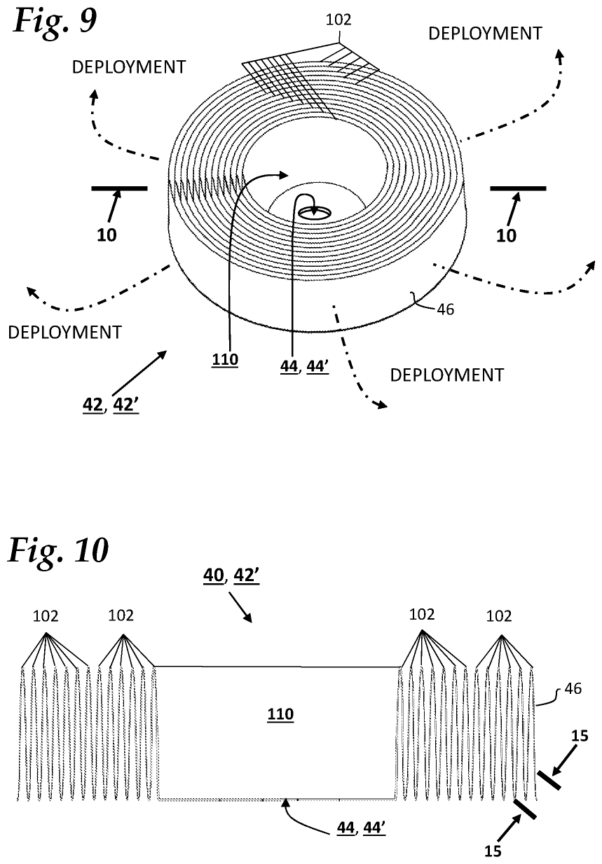

Referring to FIGS. 9 through 12 mirror support 40 or 42 are made of radially pleated shape memory sheet or foil and comprise annular corrugations 102 located concentrically to central cavity 110.

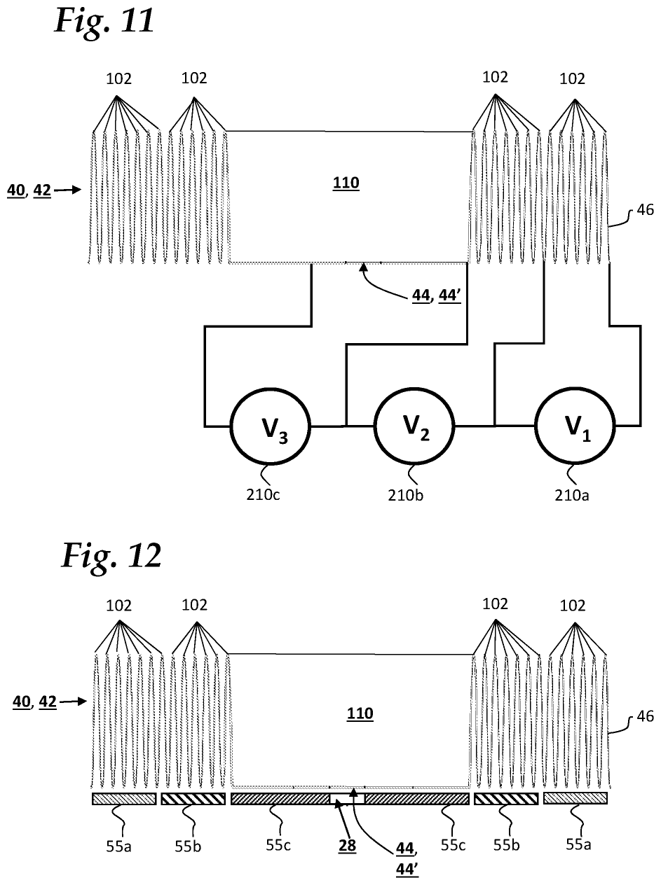

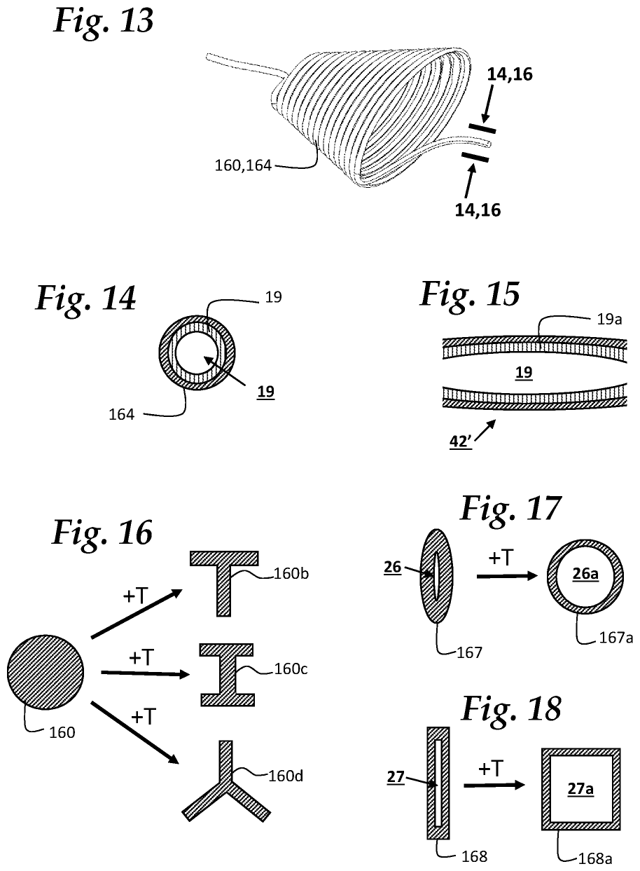

Deployment of mirror support 40 or 42 is conducted preferably sequentially in stages starting from the outermost section by either passing electrical current from sources 210a, 210b and 210c directly through the support sections, as shown on FIG. 11, or heating them sequentially with dedicated heaters 55a, 55b and 55c on FIG. 12.

The outermost corrugation becomes side wall 46 of mirror support upon deployment.

The controlled sequential deployment of sections of mirror support is preferable as it minimizes the physical size of the heating systems, because the required connections remain close to the center of the support while the support assumes its (greatly enlarged) deployed shape.

### 3b Pliable Mirror Support 450 Deployment

Referring to FIGS. 51 and 52 compliant mirror support 450 is stretched into its deployed configuration 450a via expanding coiled support hoop 400 or folded support hoop 420, which assume their respective deployed circular configurations 400a or 420a.

At its fabrication, support hoop 400 or 420 is ‘trained’ into a circular form 400a or 420a, respectively, to ‘set’ its ‘memorized’ shape. Afterwards, it is either coiled or folded into a compact pre-deployment shape 400 or 420, respectively.

Shape memory materials preferably utilized for support hoops' 400 or 420 construction, such as metallic Ni-based alloys are advantageously suited for direct heating by electric current, as they possess high electrical resistivity.

### 4. Mirror Generation Process

### 4a Spinning the Telescope in Two Orthogonal Axes

Referring to FIG. 4A telescope 52a or its variants is spun around its center of mass C_{M} in Y-axis with angular velocity ω_{Y} and precursor 60 is dispensed onto deployed mirror support 42a. Subsequently, telescope while spinning around the Y-axis, is spun up around its longitudinal Z-axis with angular velocity ω_{Z}.

Rotation around the telescope's Y-axis creates a centripetal force analogous to the gravitational force on the Earth's surface. Rotation around the telescope's Z-axis creates its own centripetal force which distributes liquid mirror precursor material 60 inside deployed mirror support 42a. The cooperative action of these two forces creates a paraboloid mirror surface.

The focal length of the resulting mirror can be calculated from the following equation (2).

$$f = \frac{{R}_{C M}}{2} {( \frac{{ω}_{Y}}{{ω}_{Z}} )}^{2} \qquad ( 2 )$$

Where
f is the focus length of the resulting paraboloid mirror
R_{CM} is the radius of rotation around telescope center of mass
ω_{Y} is angular velocity around telescope's Y-axis
ω_{Z} is angular velocity around telescope's Z-axis

The Coriolis' force contribution and liquid surface tension of mirror material 60, while would be present, to a first approximation are not included in this analysis. It is expected that the Coriolis' force will effectively tilt the center line of the created paraboloid. This tilt is predictable and ascertainable from the system operation parameters and will be readily compensated for by the mechanical design of the mirror support and downstream optical system design.

It is worth noticing that the focal length of the resulting mirror does not depend on the absolute magnitudes of the orthogonal rotational velocities but rather on their ratio.

Thus, a mirror of a given focal length can be formed with an infinite variety of orthogonal rotational velocities, including very low ones, as long as their ratio remains the same.

At lower rotational velocities the forces acting on rotating components are also lower as well, as are the resulting stresses on the system. With lower stresses on them, the system components can be made thinner and lighter.

Proper selection of the mirror material 60 and intrinsic material or surface treatment or coating of support 40a or 42a would ensure its proper wetting by material 60.

The spinning of the telescope is effected by propulsion unit 150 utilizing reactive propulsion with liquid, hot gaseous propellants (mono- and hypergolic), compressed (cold) gas jets, chemical gas generators, ion engines, and such.

The spinning of the telescope can be further controlled/assisted by tractor 138 of telescope variant 64 maintaining tension on deployed pliable boom 195a and potentially additionally applying a rotating vector to the telescope.

Alternatively, as an example, for telescope variant 52b shown on FIG. 58 simultaneous rotation around two axes can be effected by reaction wheels 500.

Rotation can also be effected for example by the deployed boom 195a on FIG. 61 which would be tensioned and rotated by tractor 138 and through it, the entire telescope mirror assembly, if 138 is constructed to have sufficient torsional stiffness.

4b. Mirror Precursor Dispensing

Mirror precursor can be deposited and held in the liquid state in the mirror support prior to deployment. Alternatively, it can be liquefied prior to mirror generation.

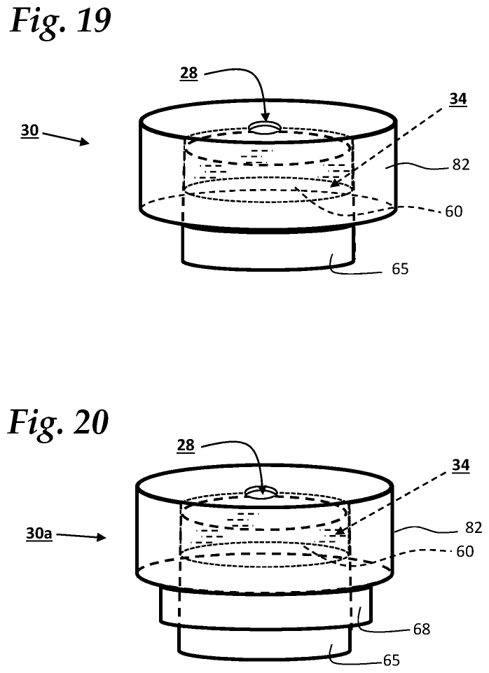

Still alternatively, referring to FIGS. 19 and 20, for direct imaging telescope type liquid mirror material precursor 60 is held in volume 34 in housing 82 of container assembly 30 or 30a. Container assembly variant 30a contains heater 68 to heat/melt mirror precursor material prior to deposition, if required.

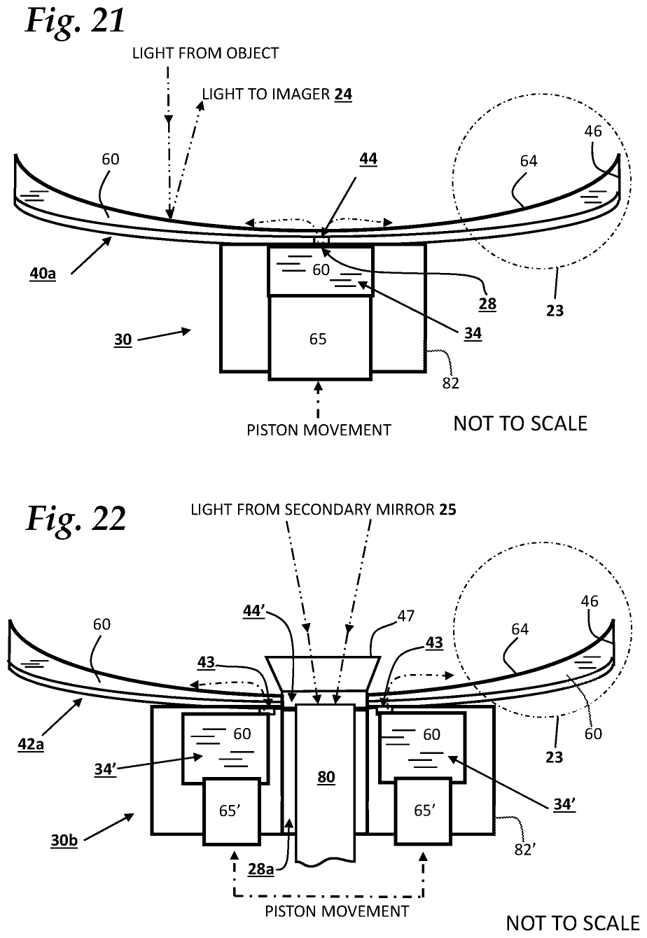

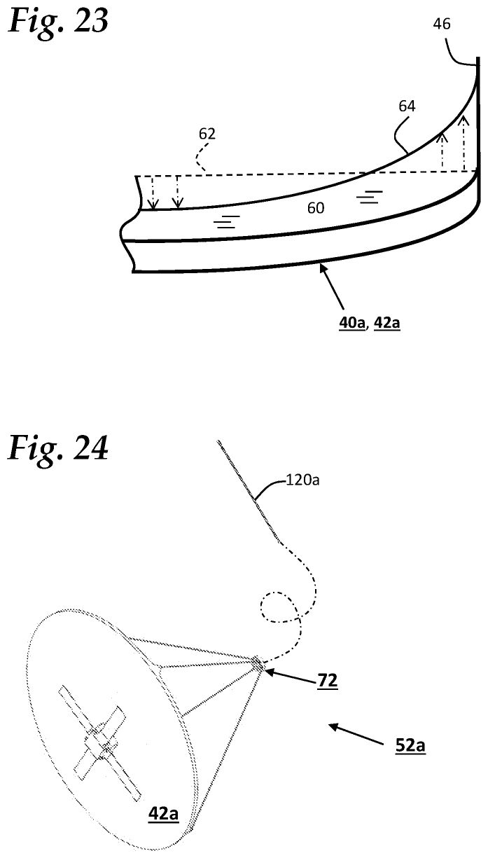

As shown on FIG. 21 precursor 60 is ejected by the action of piston 65 onto deployed support 40a via container 30 aperture 28 communicating with a corresponding aperture 44 in mirror support 40a.

As shown on FIG. 24 when liquid mirror material 60 covers the surface of support 40a, upon rotation of the telescope its outer surface transforms from the initially flat surface 62 into a smooth paraboloid surface 64. Precursor 60 is controlled on its periphery by side wall 46 formed by the distal fold of mirror support 40a.

Referring to FIG. 22, in Cassegrain-type telescope 52a precursor 60 is held in annular volume 34′ located in container housing 82′ of assembly 30c and is being expelled from it onto deployed mirror support 42a by action of annular piston 65′ through annular aperture or plurality of apertures 43 onto mirror 42a via its corresponding apertures (not shown).

A frusto-conical light baffle 47 and side wall 46 prevent precursor 60 from spilling into aperture 28a and spilling out of support 42a, respectively.

Piston 65 for expelling precursor 60 from volume 34 can be actuated by a spring, a shape memory actuator, compressed gas, an electro-mechanical drive, a pyrotechnic gas generator, and the like. Actuators of these types are well known in the art.

Assembly 30c further contains aperture 28a through which imager system 80 receives light from secondary mirror 25. Additionally, assembly 30c, if required, can contain an annular heater element similar to heater 68 to heat/melt mirror precursor material prior to deposition.

### 5. Solidification of Mirror Precursor Material

5a.

In case of liquid mercury, molten metals or polymers, two part epoxies or thermosetting polymers used as precursor, liquid mirror material 60 is then permitted to cool/polymerize and solidify, at which point the rotation of the telescope can be stopped.

The cooling rate of material 60 may have to be controlled for a particular mirror material, for example a flash cooling to create an amorphous metal ‘glass’ with superior surface quality.

Metals and alloys with low melting temperature include sodium (Na), potassium (K), indium (In), gadolinium (Ga), tin (Sn), lead (Pb) and mercury (Hg) as well as various alloys of these metals.

Thermo-setting polymers are also suitable, such as polyesters, phenolic resins, vinyl esters, polyurethane; silicones, polyamides, polyamide-imides, and others.

Thermoplastic polymers such as polypropylene, polyethylene, polyvinylchloride, polystyrene, polyethylenetheraphthalate and polycarbonate and others can be also be used.

5b. Curing of Photopolymer Precursor Material

In case of a photopolymer precursor being used, liquid mirror material 60 is cured by exposure to ultraviolet (‘UV’) light supplied by UV light source or sources 90 located in assembly 70 or 72. Most of UV-curable materials require UV irradiation in the 240-405 nm wavelength range. Such illumination is achievable with UV light-emitting diodes (LEDs), vapor-discharge lamps, or lasers. Such LEDs are commercially available. For example, UV LED Model 6868 by Inolux Company (San Jose, California, USA) produces 10 Watts of optical output at 365 nm wavelength while occupying a relatively small 6.8×6.8×3.7 mm³ envelope suitable for compact co-location of many such LEDs for a powerful precursor curing solution which would be capable of reliable and fast curing of photopolymer precursor.

Photopolymers are widely used in industry as potting and adhesive compounds. Commonly used photopolymer materials comprise cycloaliphatic epoxies, cyanoacrylates and such. For example, UV-curable polymer Model UV18Med by Master Bond Corporation (Hackensack, New Jersey, USA) is cured by exposure to 320-365 nm UV light source, does not contain or create volatile compounds and has an exceptionally low shrinkage upon curing. Another example is a UV22 nanosilica-filled UV-curable photopolymer system by Master Bond, Inc. which has high dimensional stability, very low thermal expansion coefficient and meets NASA low outgassing requirements for use in vacuum of space, thus making it suitable for the instant application.

UV-curable polymers can also be cured with ionizing radiation, such as, for example gamma rays emitted by Cobalt-60 (⁶⁰Co).

Some UV-curable photopolymers benefit from being post-cured with heat. Heat can be provided by infrared (‘IR’) or microwave sources installed for his purpose in assembly 70 or 72.

### 6. Reflective Coating(s) Deposition

6a.

Metallic precursor materials intrinsically possess high reflectivity and do not generally require reflective coatings.

6b.

In contrast, since cured photopolymers, two-part epoxies or thermoset or thermoplastic polymers do not generally possess high intrinsic reflectivity, or are transparent/translucent, they have to be coated with metallic or dielectric reflective films after the mirror is solidified.

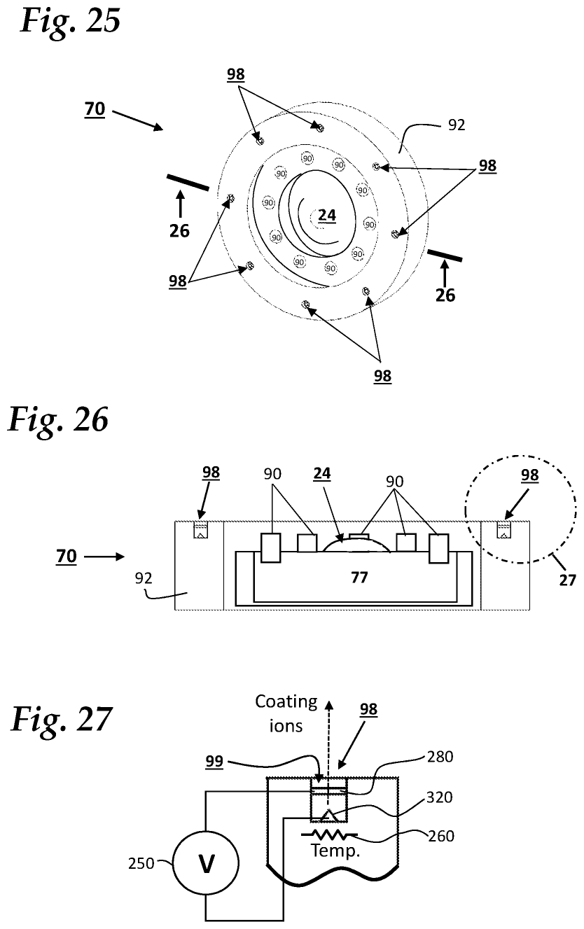

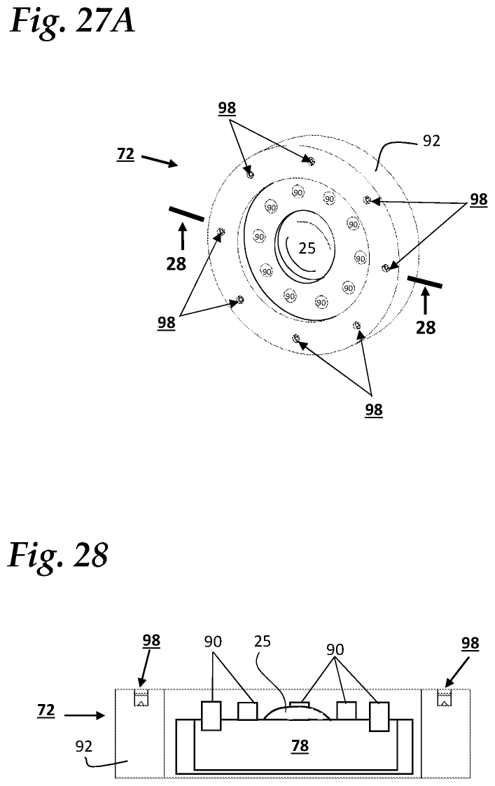

Referring to FIGS. 25 through 27, to accomplish this an evaporative source or sources 98 is used to deposit a reflective coating or a set of coatings onto the completed mirror. Source 98 can have multiple chambers each containing a separate coating material and an output opening(s) 99 facing surface 64 of mirror 40a. To enable deposition, coating material is heated or vaporized by heater 260 and then its vapor is ionized and accelerated towards the mirror surface by a high voltage source 250 connected between coating material 320 and accelerating grid 280. To concentrate the electric field and enable more efficient emission of the coating atoms, the shape of coating material source 320 can be made into a sharp-tipped cone, as shown on FIG. 27. The deep vacuum of space where the in-situ coating deposition coating operation takes place is uniquely suitable for it.

Alternatively, instead of direct heating of material sample 320 by heater 260, it can be heated and vaporized with an electron beam or a laser beam, as is known in the art.

While providing momentum to the coating particles via accelerating voltage also helps to keep their stream pointed onto the mirror surface and minimize or eliminate its spillover and possible contamination of the adjacent telescope structures. Any coating particles not intercepted by mirror support 40a or 42a or 450a will be launched into space and away from telescope due to their acquired momentum.

To further prevent coating materials from settling onto-and potentially contaminating the nearby imager system 24, source(s) 98 can be recessed with respect to the coater output openings 99 as shown on FIGS. 25 and 26.

Several sources 98 may contain different materials and their respective deposition can be independently controlled, simultaneously or sequentially, to effect, for example, a multi-layer coatings.

The coating materials can comprise metals, for example gold (Au), silver (Ag) or aluminum (Al), or dielectric materials such as SiO₂, Si₃N₄, CaF₂, GeO₂, MgF₂, Al₂O₃. High reflectivity multilayer coatings utilizing these and similar materials are well known in the art.

For example, high reflectivity multilayer coatings are customarily made with alternating layers of materials with low refractive indices such as magnesium fluoride (MgF₂) and silicon dioxide (SiO₂) and materials with large refractive indices, such as zinc sulfide (ZnS) and titanium dioxide (TiO₂). For high reflectivity in extreme ultra-violet (EUV) alternating layers of molybdenum (Mo) or tungsten (W) can be interposed with lightweight materials such as silicon (Si).

Since the mirror operates exclusively in the deep vacuum of space, chemically reactive materials otherwise unsuitable for terrestrial applications, such as alkali metals, may also be readily used for coatings. Advantageously, some alkali metals such as potassium (K) have unique reflectance properties which can be advantageously exploited in space environment.

### 7. Imaging

7a. Imaging by Direct Imaging Telescope

Direct telescope imaging is effected by direct imager system 24 located in integrated assembly 70 shown on FIGS. 25 through 27.

Imager system 24 captures image created by telescope's primary mirror and provides it in electronic form for downstream post-processing. System 24 may contain several distinct optical instruments (not shown in detail) as is frequent for space imaging systems.

Assembly 70, comprises enclosure 92 which, in addition to imager system 24 contains integrated controller 77, UV curing sources 90 and coating deposition sources 98. Controller 77 may contain image post-processing and transport hardware in addition to sub-controllers for curing sources 90 and coating deposition sources 98.

7b. Imaging by Cassegrain-Type Telescope

For the Cassegrain-type telescope configuration 52a secondary convex mirror 25 located in integrated assembly 72 conveys light reflected by the primary mirror to imager system 80 located in main system enclosure 170.

Referring to FIG. 22 light reflected by secondary mirror 25 reaches imager system 80 through aperture 44′ in primary mirror 42a. System 80 is shielded from stray light by baffle 47 which also serves as a wall for liquid precursor 60 used for mirror generation.

System 80 may contain several distinct optical instruments (not shown in detail) as is frequent for space imaging systems.

Integrated assembly 72 shown on FIGS. 27A and 28 is similar to assembly 70 but its controller 78 does not contain image processing capability.

### 8. Mirror Support Deployment and Surface Creation Operations Sequences

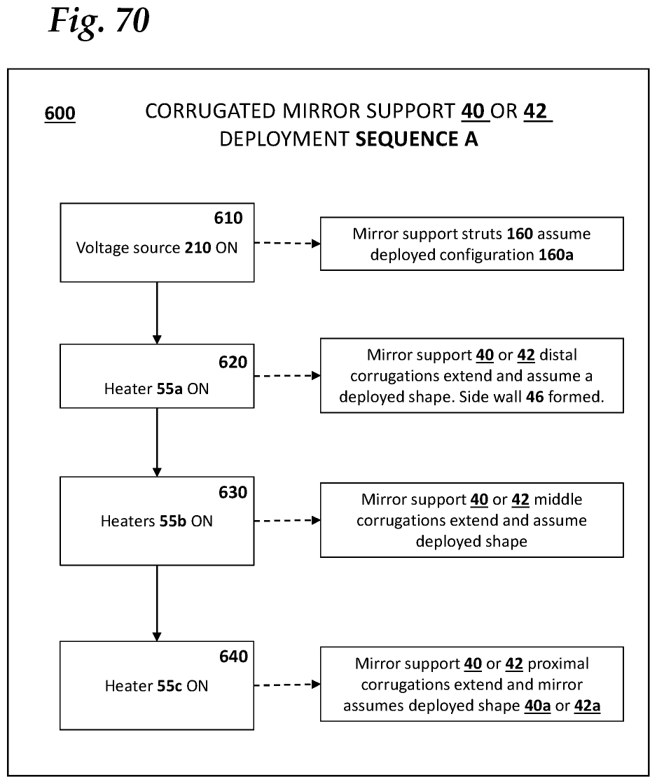

Referring to FIG. 70, sequence 600 pertains to deployment Sequence A of mirror support 40 or 42 which utilizes heaters for deployment.

Struts 160 are extended by activating voltage source 210 (step 610), passing electric current directly through struts 160, heating them above their material's transition temperature and extending them into their deployed configuration 160a.

Heater 55a is activated (step 620) and distal corrugated portion of mirror support 40 or 42 extends outwardly with the outermost fold forming a side wall 46.

Subsequently, heaters 55b and 55c are sequentially activated (in steps 630 and 640, respectively) which causes middle-and proximal corrugations of support 40 or 42 respectively to extend, and the entire support to assume its deployed configuration 40a or 42a.

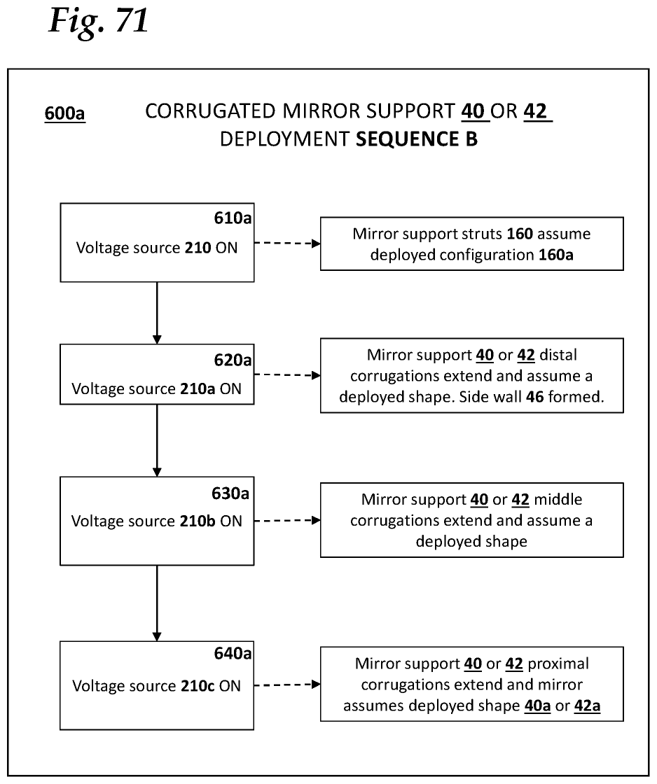

Referring to FIG. 71, sequence 600a pertains to deployment Sequence B of mirror support 40 or 42.which utilizes direct heating with electrical current.

Struts 160 are extended by activating voltage source 210 (step 610a), passing electric current directly through struts 160, heating them above their material's transition temperature and extending them into their deployed configuration 160a.

Voltage source 210a is activated (step 620a) and heats up distal corrugated portion of mirror support 40 or 42 which as a result extends outwardly with the outermost fold forming side wall 46.

Subsequently, voltage sources 210b and 210c are sequentially activated (in steps 630a and 640a, respectively) which causes middle-and proximal corrugations of support 40 or 42 respectively to heat and extend, and the entire support to assume its deployed configuration 40a or 42a.

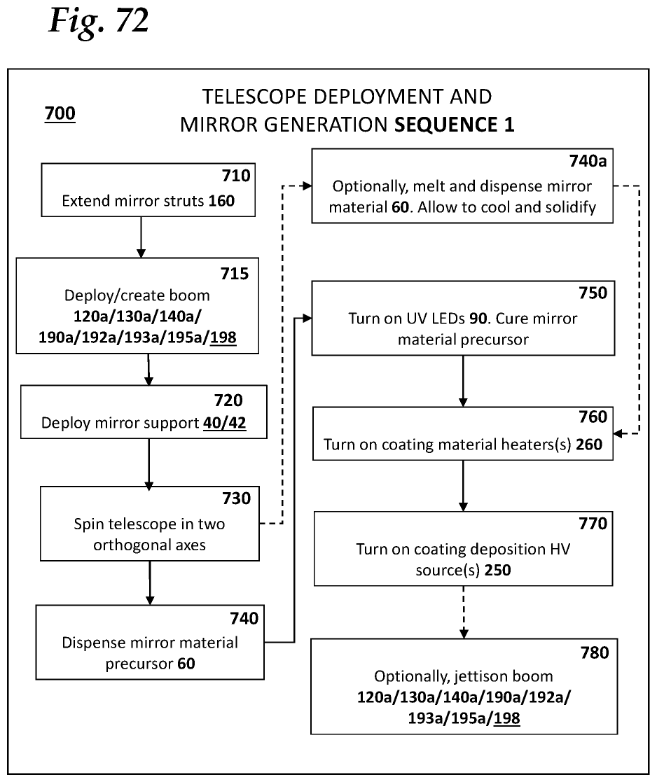

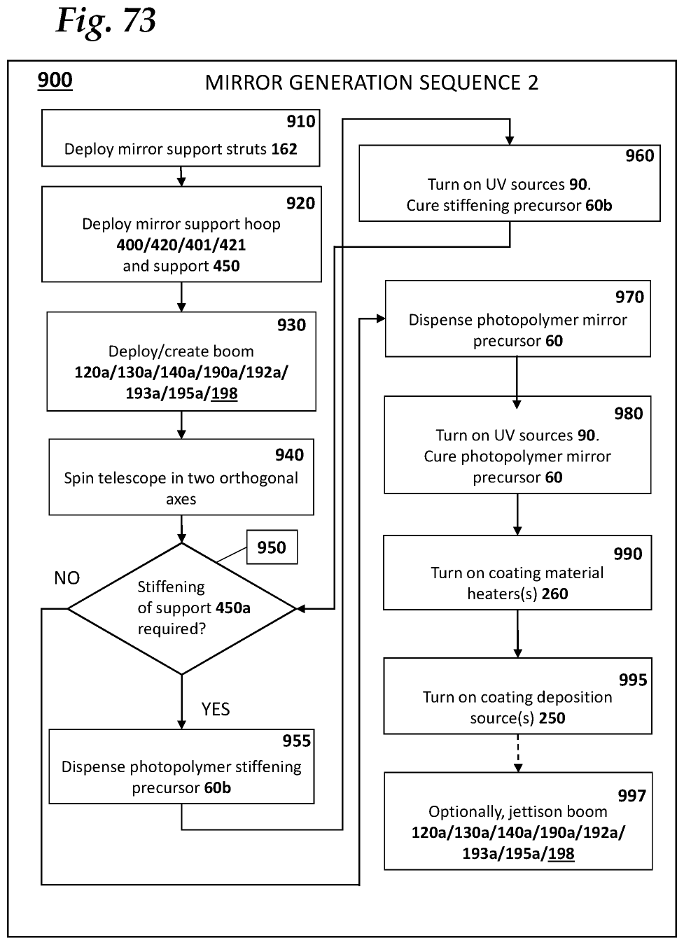

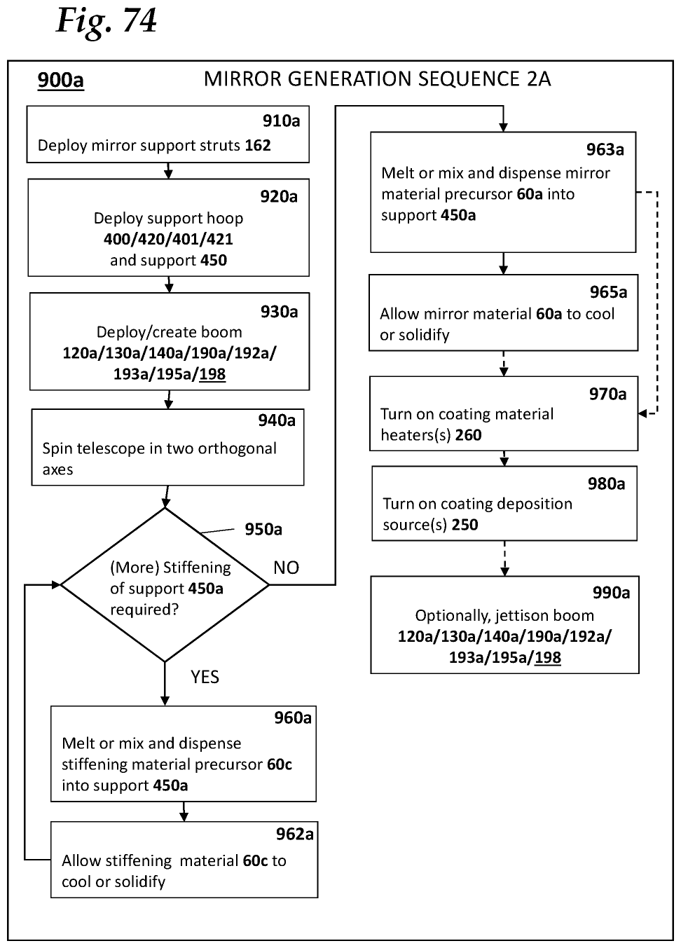

Referring to FIG. 72, in sequence 700 which pertains to mirror surface generation Sequence 1, supports 160 are extended by passing through them electric current supplied by voltage source 210 (step 710).

Subsequently, boom 120a or 130a or 140a or 190a or 192a or 193a or 195a or 198 is deployed or formed (step 715).

Mirror support 40 or 42 is then deployed and assumes its deployed respective configuration 40a or 42a as described previously (step 720).

Telescope is then spun around two orthogonal axes (step 730).

Photopolymer precursor material 60 is then dispensed into support 40a or 42a (step 740) and, still in liquid state, creates a paraboloid surface due to telescope spinning action.

Precursor 60 is then cured into solid paraboloid form by its exposure to UV light(s) 90 (step 750). Steps 740 and 750 may be repeated to build up the mirror thickness, without stopping rotation of the telescope.

In case of a meltable precursor 60, it is first melted and then dispensed in step 740a bypassing UV curing step 750.

After precursor 60 solidified, coating material heater(s) 260 of integrated assembly 70 or 72 are turned on causing melting and/or vaporization of coating material(s) 320 (step 760).

Subsequently high voltage source(s) 250 is activated which applies high voltage to accelerating grid(s) 280 of integrated assembly 70 or 72 which ionizes and propels coating ions toward the mirror surface.

After coating deposition is finished (by, for example, monitoring reflectivity of the mirror by a probe beam), coating operation is complete.

If precursor 60 has high native reflectivity (for example being a metal), the coating steps 760 and 770 can be omitted.

After the mirror has been formed and coated, the boom can be optionally jettisoned in step 780.

### ADDITIONAL SYSTEM COMPONENTS IMPLEMENTATIONS AND PROCCESS SEQUENCES

### Pliable Mirror Support 450 Deployment

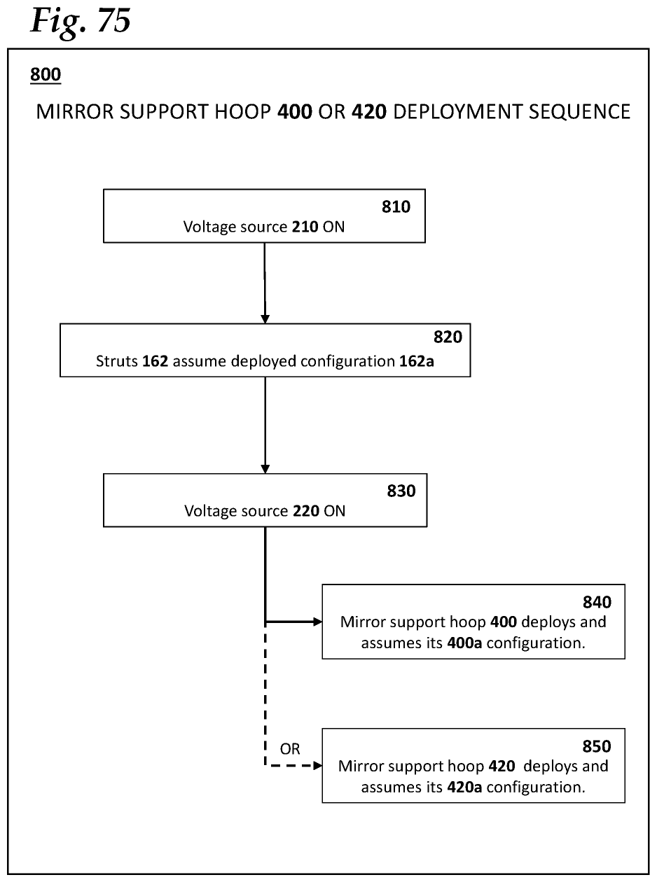

FIG. 75 shows a sequence 800 which pertains to deployment of support hoops 400 or 420 for pliable mirror support 450 deployment.

Voltage source 210 is activated (step 810) and heats up struts 162 which assume their deployed configuration 162a (step 820).

Voltage source 220 is then activated (step 830) and directly heats coiled hoop 400 by passing electric current through it. As a result, hoop 400 assumes its deployed circular configuration 400a (step 840). Alternatively, if folded hoop 420 is used instead, source 220 heats it up and it assumes its respective circular shape 420a (step 850).

### Mirror Support Hoop Super-Elastic Variants and Their Deployment

Mirror support hoop 400 or 420 can be made self-opening by exploiting the super-elastic properties of shape-memory materials, such as, for example NiTi (‘nitinol’) alloys. At above their phase-transition temperatures such alloys exhibit super-elastic properties which are characterized by very large elastic coefficients: the items made from them after removal of constraint return to their original shape even after being greatly deformed.

Mirror support hoop 401 or 421 made from these materials and operated in its super-elastic mode (vs. temperature-sensitive shape-memory mode), unfold on its own in space into its deployed shape 401a or 420a once released, after being compressed into-and held in its respective stowed configurations.

Referring to FIG. 55 super-elastic variant 401 of coiled hoop 400 is prevented from premature deployment by a fitted over it toroidal restraining sleeve 407 made of heat-meltable polymer mesh.

A circular thermal cutter 407 is positioned on sleeve 405 along its circumference. Upon being heated by electrical current supplied by source 221, cutter 407 thermally cuts through sleeve 405 which opens up, releasing hoop 401 which assumes its deployed configuration 401a. This deployment mechanism is well known in the art.

Referring to FIG. 56 a heat-meltable polymer cord 411 constrains super-elastic variant 421 of folded support hoop 420 to prevent its premature deployment from its stowed configuration. A thermal cutter 413 located across cord 411 upon being heated by electrical current supplied by source 221 thermally cuts through cord 411 releasing hoop 421 which subsequently assumes its deployed configuration 421a. This type of deployment mechanism is well known in the art.

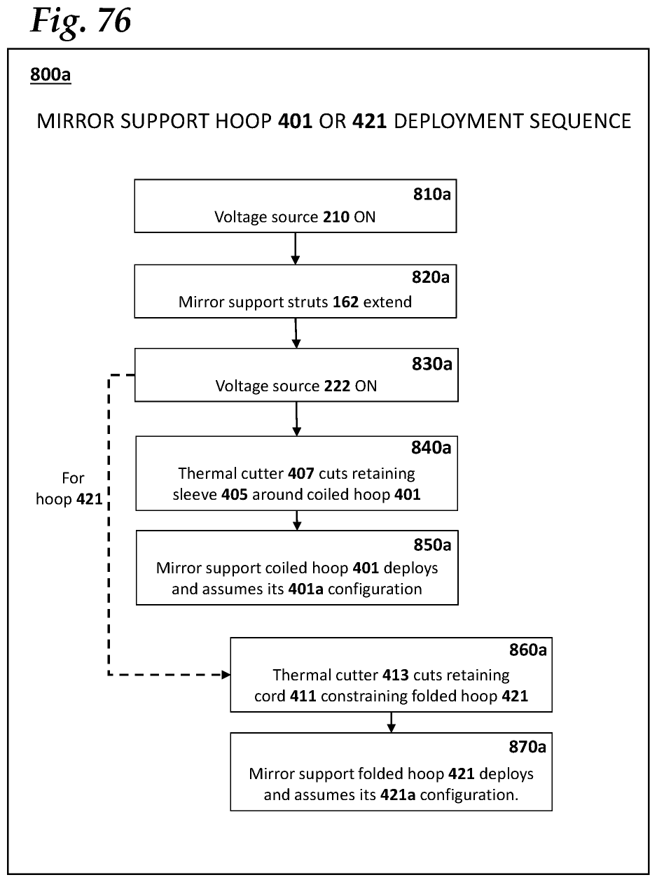

FIG. 76 details deployment sequence 800a for superelastic mirror support hoops 401 and 421. With the voltage source 210 activated (step 810a), lower struts 162 extend (step 820a). Voltage source 220 is then activated (step 830a) and heats up thermal cutter 407. Cutter 407 then cuts through sleeve 405 (step 840a) releasing hoop 401 which assumes its deployed circular configuration 401a.

Alternatively, if folded superelastic mirror support 421 is used, steps 830a and 850a are substituted by steps 860a and 870a, where thermal cutter 413 cuts through retaining cord 411 releasing superelastic folded hoop 421 which assumes its deployed circular configuration 421a, respectively.

### Mirror Performance Testing, Calibration and Repair

To verify mirror shape and to test its alignment and surface quality telescope is oriented to point towards a bright star, which can serve as a virtually ideal point light source.

By analyzing the shape and size of the image of the star the surface quality of the mirror, its shape and alignment can be ascertained. By utilizing the results of these measurements the subsequent images produced by the imager system 24 can be optically or digitally corrected if required. The calibration and verification can be repeated periodically throughout the service life of the telescope if there is a suspicion that the mirror shape and alignment have somehow changed.

If the mirror has been damaged, deformed, its surface has aged, or if there was a defect produced during its generation, it can potentially be over-cast with a new layer of liquid precursor. To re-cast the mirror surface with a molten or mixed precursor, the precursor material melting or mixing, casting and coating (if required) operations will be repeated and telescope be re-spun. The entire mirror can be heated for the material to melt, or a new batch of the mixed or molten precursor material deposited onto the existing material layer. In the former case, mirror support 40a or 42a will have to contain a heater or heaters.

To overcoat the mirror an additional batch of liquid mirror precursor is dispensed onto the previously solidified mirror surface 64. Telescope is then re-spun to spread precursor material and for it to form new paraboloid surface 64, and then the precursor is allowed to cool and solidify, or, in case of a photopolymer 60 used, it is again cured with UV light source(s) 90 and coated as previously. This operation will necessitate an additional capacity of the precursor material holding tank 30 and its variants, or additional precursor holding tanks, or a controlled dispensing action of material expelling piston 65 which will not dispense the entire volume of precursor 60 in the first mirror forming operation, but will preserve some for potential re-casting operations. A dedicated heater in addition to heater 63 may be required to maintain precursor 60 in liquid form, or to heat/thaw it prior to dispensing.

### Precursor Material Variants

Numerous precursor material variants are suitable for generating the mirror, such as:
a. alkali metals,
b. aluminum,
c. mercury,
d. metals and alloys thereof,
e. metal glasses and alloys thereof,
f. epoxies and mixtures thereof,
g. epoxies containing thermal expansion coefficient-reducing additives,
h. thermoplastic polymers and mixtures thereof,
i. thermoplastic polymers containing thermal expansion coefficient-reducing additives,
j. thermosetting polymers and mixtures thereof,
k. thermosetting polymers containing thermal expansion coefficient-reducing additives,
l. glasses and mixtures thereof,
m. pitch and mixtures thereof,
n. sugar solutions,
o. aqueous solutions and
p. photocurable polymers and mixtures thereof.
q. photopolymers containing thermal expansion coefficient-reducing additives,
r. cycloaliphatic epoxies and mixtures thereof,
s. cyanoacrylates and mixtures thereof
t. styrenic compounds,
u. vinyl ethers,
v. N-vinyl carbazoles,
w. lactones,
x. lactams,
y. cyclic ethers,
z. cyclic acetals,
aa. cyclic siloxanes,
bb. phthalic diglycol diacrylates,

### Precursor Container Variants

Several variants of container system 30 for the mirror precursor material 60 are presented on FIGS. 18 through 20. Container 30 comprises a case 82 with internal cavity 34 containing liquid precursor material 60. Orifice 28 permits the outflow of material 60 onto deployed mirror support 40a.

Precursor container variant 30a in addition comprises heater 63 to melt material 60. This container can be used with material 60 which would be solid or excessively viscous during launch. Piston 65 used to expel precursor can be actuated with a pre-compressed spring, a shape-memory type actuator, electrical motor driving a screw-type actuator assembly or an eccentric, compressed gas, or with a pyrotechnic gas generator.

Precursor container variant 30c is made annular and comprises central aperture 28a through which imaging can take place.

### Heat Pipe Implementations for Shape Memory Components

Utilizing heat pipe technology facilitates fast heating and subsequent deployment of shape-memory components since their heating does not rely on a relatively slow heat diffusion phenomenon or direct heating with electric current, but rather employs a heating source only at the proximal end of the part.

Using heat pipe technology also simplifies overall system design by removing the necessity to provide electrical connections on both (proximal and distal) ends of deploying components if their direct electrical heating is employed.

Mirror supports 40 and 42, struts 160, corrugated boom 150, coiled boom 190, coiled boom elements 165 and support hoops 400 and 420 can all be realized as heat pipes rather than solid parts.

For example, a heat pipe variant 164 of strut is shown in cross section on FIG. 14 as a hollow member with internal lumen 19 containing wick 19a for transport of vapor and liquid phases of the heat pipe working fluid.

FIG. 15 shows cross section of heat pipe variant 42′ of mirror support 42 taken along the line 15-15 on FIG. 10. It comprises lumen 19 and wick 19a to respectively contain and transport vapor and liquid phases of heat pump fluid.

### Strut Variants

Additionally, struts 160 can be formed to transform from cylindrical cross section into a ‘T’—(160b), an ‘I’—(160c) or a ‘Y’—(160d) cross sections upon heating and deployment, as shown on FIG. 16. These cross sections are lighter than a solid cylinder while preserving its stiffness.

Similarly, as shown on FIGS. 17 and 18 strut 160 variants 167 and 168 can have hollow non-round cross sections with corresponding narrow lumens 26 and 27, which upon application of heat expand into tubular cross sections 167a and 168a (in addition to un-coiling and extending) with corresponding fully open lumens 26a and 27a. Struts of these cross sections would have different mechanical, physical and system characteristics, such as directional stiffness, weight vs. solid rod struts, and/or be particularly suitable for routing signal and/or power cables to image/cure/coat assembly 70. In addition, their flattened shape would facilitate their compact bending or coiling for stowage.

Additionally struts 160 and 162 can be 3-D printed or extruded, similarly, for example to boom 130.

### System Components Superelastic Implementations

Most of the shape memory-based system components can be implemented in their superelastic variants. Above their transition temperature, shape memory materials behave superelastically, so, for example the NiTi alloys similar to shape memory types (albeit having different stoichiometry) can be used for superelastic components.

For example, mirror supports 40 and 42 can be made from superelastic materials, folded/compressed and mechanically constrained prior to deployment, and deploy spontaneously into their original shape when the constraints are removed.

Similarly, struts 160 and 162 can be made superelastic, as well as some booms, for example 120, 140, 192 and 193.

### Deployment Speed Retarders and Vibration Dampers Use

Due to the boom's high length-to-diameter aspect ratio, during its own deployment or forming and mirror forming and potentially aiming maneuvers it is expected to experience various vibrational and twisting moments.

In the vacuum of space and depending on the mechanical losses of the boom structure these moments can generate persistent oscillations unless controlled.

This is particularly important for superelastic-type deployable elements which may store significant mechanical potential energy, in order to achieve their ‘soft’ deployment and avoid large oscillations and/or vibration.

Therefore, retarding, deployment speed-controlling and energy dissipating devices and structures in addition to, for example 300 used in boom variant 140, and binder/snubber disks 302 of boom 198 are proposed as well.

For this function, the binding agent used to attach disk 302 to members 205a can be a viscoelastic polymer, or the disk itself can be made to contain piezo-electric elements which would convert mechanical vibrations into electrical charges and then dissipate them.

Piezo-electric or mechanically dampening coatings or laminates or embedded (in case of members 205, for example) are possible. Additionally, the outer layer of cable 196 can be made of-or contain piezo-electric energy dissipating fibers or devices. These vibration energy absorbing techniques are known in their respective arts.

Alternatively, magnetic-type dampers utilizing eddy currents can be used. For example, a permanent magnet surrounding a conductive rod (for example, strut 160) would induce eddy currents when the rod is moving inside the magnet's field, generating opposing e.m.f., reducing movement and would eventually dissipate energy via ohmic losses. Such devices are known in the art and are operational at cryogenic temperatures encountered in space.

### Precursor Curing Source Variants.

Curing light sources 90 do not have to produce just an ultraviolet light in order to cure precursor 60, but visible or even infrared light can be used instead of-or in conjunction with, UV. Some photopolymers can be cured by visible light, as described in U.S. Pat. No. 9,902,860 to Li et al., or even by either UV or IR radiation per U.S. Pat. No. 5,466,557 to Haley et al. Yet other photopolymers are best cured by a combination of UV exposure followed by thermal/IR post-curing.

Alternatively, heating and curing of the precursor can be done with microwaves. Since sun's radiation emission spectrum peaks in the violet, UV-curable precursor photopolymers can be exposed to sunlight for curing, either as a backup to the UV sources, or the precursor primary curing mechanism. This is advantageous for large and very large mirrors for which large and very powerful UV light sources may be challenging to implement.

Additionally, cross-linking of precursor polymeric material(s) can be accomplished by exposing them to other types of radiation, such as for example, of ionizing type.

To that extend, to enable fast cure of epoxy-type precursors of both photo-curable and two-part types, and enable their curing even in very thick cross sections, ionizing radiation source(s) can be used.

For example, a Cobalt-60 (⁶⁰Co) gamma-ray source would fast cure/crosslink epoxies at significant layer thicknesses. An alternative gamma-ray source could be Iridium-192 (¹⁹²Ir).

There is also a number of other radioactive gamma emitters that have a very wide range of half-lives and photon energies that can be selected for a particular mission.

The use of such sources for curing/cross-linking epoxies and polymers is known in the art.

Because high energy gamma rays such as created by Cobalt-60 readily penetrate metals, the gamma ray source can be contained in the main system enclosure and pointed outwards, through mirror support, to illuminate and cross link mirror material precursor ‘from below’.

Mirror support 40a or 42a may be made reflective on its both surfaces to minimize heating by sunlight and minimizing the resulting heat-induced stress in the formed mirror.

Alternatively, it can have a thermally absorbent coating on its obverse surface, to facilitate melting of solid precursors by the sun.

Dispensing of liquid precursor photopolymers may proceed in several successive stages, to enable curing of a single layer at a time, if required.

Composition of the deposited precursor layers can be made to vary by pre-filling precursors in the precursor container in a particular sequence or by employing several precursor material dispensers in sequence.

While described reflective coating deposition process uses vaporized material deposition, other ways of depositing reflective and protective coatings can be used for the mirror. For example, there exists a well-known material sputtering process. Additionally, chemical metals deposition techniques exist, such as ‘electro-less’ nickel, tin and copper deposition processes.

### Additional System Features

1. While precursor material is dispensed from container assembly 30 at the center of mirror support 40, the dispensing can be conducted from elsewhere as well, for example at the periphery of support 40, or 42, or 450.

To accomplish the filling of the mirror support the rotation of telescope has to be controlled, for example, by initially spinning the telescope around the Y-axis with angular velocity ω_{Y} and generating ‘artificial gravity’ as shown on FIG. 4A. This rotation would force liquid precursor 60 from the periphery of deployed support 40a or its equivalents into its center. While maintaining rotation around the Y-axis, telescope is then spun around its Z-axis with ω_{Z} angular velocity. The simultaneous rotation in both axes then generates a paraboloid surface in the liquid precursor 60.
2. Electrical contacts 15 used for direct heating of shape memory components by electric current can be made to disengage from the heated components upon deployment. They can also be made frangible, to also disengage from the components upon their deployment.
3. Although not shown, telescope of instant invention will also contain wireless communication means for receiving commands and transmitting acquired images.
4. In addition, although not shown, telescope of instant invention will include various electronics control-, power-and cooling systems necessary for its operation.
5. Imager system 24 or 80 can have a shutter to protect it from direct sunlight exposure.
6. Precursor material 60 may have additives or fillers to affect its flowing/filling properties in liquid state, melting or softening temperature, reflectance and/or dimensional stability after solidification. For example, nanosilica additives increase photopolymers post-cure dimensional stability.
7. Booms and their associated deployment systems of the instant inventions are interchangeable.

Although descriptions provided above contain many specific details, they should not be construed as limiting the scope of the present invention.

All features disclosed in the specification, including the claims, abstract, and drawings, and all the steps in any method or process disclosed, may be combined in any combination, except combinations where at least some of such features and/or steps are mutually exclusive.

Each feature disclosed in the specification, including the claims, abstract, and drawings can be replaced by alternative features serving the same, equivalent, or similar purpose, unless expressly stated otherwise.

Thus, the scope of this invention should be determined from the appended claims and their legal equivalents.

I claim:

1. A space-based imaging system comprising
an imaging mirror,
said mirror having a generally parabolic cross section along at least one of its axes,
said mirror supported by a mirror support structure,
wherein said mirror is produced from solidified liquid precursor material while said imaging system is in space,
wherein said mirror support structure comprises substantially a disk,
said disk further comprising a top surface and a bottom surface,
said disk further comprising circular edge wall,
said wall perpendicular to said top surface of said disk,
said wall located along a periphery of said disk and in communication therewith,
wherein said system further comprises a substantially elongated counterweight boom,
said boom perpendicular to said top surface of said disk,
said boom disposed to face said top surface of said disk and extend distally from it,
said boom located along the line through the center of said top surface of said disk,
said boom in communication with said imaging system by its proximal terminus only,
said disk capable of being rotated around a first axis,
said first axis perpendicular to said top surface of said disk and disposed through a center of combined mass of said disk and said boom,
said disk capable of being simultaneously rotated around a second axis,
said second axis orthogonal to said first axis,
wherein center of rotation around said second axis is disposed through a center of combined mass of said disk and said boom.

2. The system of claim 1, further comprising at least one reflective coating on said mirror surface, said coating deposited onto said mirror surface while said imaging system is in space.

3. The system of claim 1 wherein said mirror support structure further comprises at least one light baffle.

4. The system of claim 1 wherein said mirror support structure further comprises at least one aperture.

5. The system of claim 1, wherein said precursor material is selected from the group consisting of:
a. alkali metals,
b. aluminum,
c. mercury,
d. metals and alloys thereof,
e. metal glasses and alloys thereof,
f. epoxies and mixtures thereof,
g. epoxies containing thermal expansion coefficient-reducing additives,
h. thermoplastic polymers and mixtures thereof,
i. thermoplastic polymers containing thermal expansion coefficient-reducing additives,
j. thermosetting polymers and mixtures thereof,
k. thermosetting polymers containing thermal expansion coefficient-reducing additives,
l. glasses and mixtures thereof,
m. pitch and mixtures thereof,
n. sugar solutions,
o. aqueous solutions and
p. photocurable polymers and mixtures thereof.
q. photopolymers containing thermal expansion coefficient-reducing additives,
r. cycloaliphatic epoxies and mixtures thereof,
s. cyanoacrylates and mixtures thereof
t. styrenic compounds,
u. vinyl ethers,
v. N-vinyl carbazoles,
w. lactones,
x. lactams,
y. cyclic ethers,
z. cyclic acetals,
aa. cyclic siloxanes,
bb. phthalic diglycol diacrylates,

6. The system of claim 1 further comprising at least one radiation source, said radiation source emitting radiation capable of solidifying said precursor upon exposure.

7. The system of claim 1, wherein said precursor material is liquefied while in space prior to production of said mirror.

8. The imaging system of claim 1, further comprising rotation system,
said rotation system capable of rotating said imaging system simultaneously along said first axis and said second axis,
said rotation system is selected from the group consisting of:
a. propulsion systems based on chemical reactions,
b. propulsion systems based on decomposition of materials,
c. propulsion systems based on vaporization,
d. propulsion systems based on compressed gas or gases,
e. positioning systems based on moving inertial mass or masses,
f. propulsion systems based on ion propulsion.

9. The imaging system of claim 1, wherein said mirror support structure further comprises a heater.

10. The imaging system of claim 1, wherein said mirror support material is selected from a group consisting of:
a. shape memory materials,
b. superelastic materials,
c. pliable materials.

11. The imaging system of claim 1, wherein said boom is selected from a group consisting of:
a. deployable structures created via additive manufacturing process or processes,
b. deployable structures created via extrusion process or processes,
c. deployable structures made with shape memory materials,
d. deployable foldable structures,
e. deployable telescopic structures,
f. deployable uncoiling helical structures,
g. deployable structures comprising pliable members which stiffen during and after deployment,
h. deployable structures comprising pliable members which form stiff assemblies when held together during and after deployment,
i. pliable members deployed and tensioned by a tractor craft,
j. deployable structures made with shape memory materials utilizing heat pipe technology,
k. hereinabove members comprising counterweight at their distal termini,
l. hereinabove members comprising deployment velocity reducing elements,
m. hereinabove members comprising vibration reducing elements.

12. The imaging system of claim 1, wherein said boom is capable of being severed from the rest of said system.

13. A space-based imaging system comprising
an imaging mirror assembly,
said mirror assembly further comprising a mirror support,
said support comprising substantially a disk,
said disk further comprising a top surface and a bottom surface,
said top surface further comprising a substantially circular wall along its periphery,
said wall perpendicular to said top surface and in cooperation therewith,
said imaging system further comprising a substantially elongated counterweight boom,
said boom perpendicular to said top surface of said disk,
said boom disposed to face said top surface of said disk and extend distally from it,
said boom in communication with said imaging system by its proximal terminus only,
said imaging system capable of rotating along two orthogonal axes, namely, first axis and second axis, said first axis passing perpendicular to said top surface of said support and through combined center of gravity of said support and said boom, wherein a center of rotation around said second axis is through center of gravity of said support and said boom,
said imaging system further comprising a dispensing mechanism for introducing liquid precursor material into said support to produce said mirror upon solidification,
said mirror produced while said system is in space.

14. The system of claim 13, wherein said precursor material is selected from the group consisting of:
a. alkali metals,
b. aluminum,
c. mercury,
d. metals and alloys thereof,
e. metal glasses and alloys thereof,
f. epoxies and mixtures thereof,
g. epoxies containing thermal expansion coefficient-reducing additives,
h. thermoplastic polymers and mixtures thereof,
i. thermoplastic polymers containing thermal expansion coefficient-reducing additives,
j. thermosetting polymers and mixtures thereof,
k. thermosetting polymers containing thermal expansion coefficient-reducing additives,
l. glasses and mixtures thereof,
m. pitch and mixtures thereof,
n. sugar solutions,
o. aqueous solutions and
p. photocurable polymers and mixtures thereof.
q. photopolymers containing thermal expansion coefficient-reducing additives,
r. cycloaliphatic epoxies and mixtures thereof,
s. cyanoacrylates and mixtures thereof
t. styrenic compounds,
u. vinyl ethers,
v. N-vinyl carbazoles,
w. lactones,
x. lactams,
y. cyclic ethers,
z. cyclic acetals,
aa. cyclic siloxanes,
bb. phthalic diglycol diacrylates,

15. The system of claim 13 wherein said support structure further comprises at least one light baffle.

16. The system of claim 13 wherein said support structure further comprises at least one aperture.

17. The system of claim 13 wherein said support structure further comprises at least one heating element.

18. The imaging system of claim 13, wherein said mirror support material is selected from a group consisting of:
a. shape memory materials,
b. superelastic materials,
c. pliable materials.

19. The system of claim 13, wherein said boom is selected from a group consisting of:
a. deployable structures created via additive manufacturing process or processes,
b. deployable structures created via extrusion process or processes,
c. deployable structures made with shape memory materials,
d. deployable foldable structures,
e. deployable telescopic structures,
f. deployable uncoiling helical structures,
g. deployable structures comprising pliable members which stiffen during deployment,
h. deployable structures comprising pliable members which form stiff assemblies when held together during deployment,
i. pliable members deployed and tensioned by a tractor craft,
j. deployable structures made with shape memory materials utilizing heat pipe technology,
k. hereinabove members comprising counterweight at their distal termini,
l. hereinabove members comprising deployment velocity reducing elements,
m. hereinabove members comprising vibration reducing elements.

20. The system of claim 13 further comprising rotation inducing system, said rotation inducing system capable of rotating said imaging system simultaneously around said first axis and said second axis.

21. The system of claim 13 wherein said dispensing mechanism comprises a container, said container containing said precursor material, said container further comprising an egress aperture for said precursor material, said aperture communicating with said mirror support.

22. The container of claim 21 further comprising at least one heater element.

23. The container of claim 21 further comprising a piston within,
said piston capable of moving inside said cylinder, said piston capable of ejecting said precursor material through said egress aperture,
said piston being driven by a piston driving mechanism.

24. The container of claim 23 further comprising at least one heater element.

25. The container of claim 23 wherein said piston driving mechanism is selected from the group consisting of:
a. compressed gas,
b. compressed elastic element,
c. shape memory actuator,
d. electrical motor drive assembly,
e. pyrotechnical gas generator
f. gas or vapor generator based on decomposition of materials.

26. The imaging system of claim 13 further comprising at least one radiation source, said radiation source emitting radiation capable of solidifying said precursor upon exposure.

27. The imaging system of claim 13 further comprising a rotation system, said rotation system capable of rotating said imaging system simultaneously along said first axis and said second axis,
said rotation system is selected from the group consisting of:
a. propulsion systems based on chemical reactions,
b. propulsion systems based on decomposition of materials,
c. propulsion systems based on vaporization,
d. propulsion systems based on compressed gas or gases,
e. positioning systems based on moving inertial mass or masses,
f. propulsion systems based on ion propulsion.

28. A method of producing while in space an imaging system based on a paraboloid mirror comprising the steps of:
a. providing mirror support structure,
said support structure comprising substantially a circular disk,
said disk comprising two surfaces, namely, a top surface and a bottom surface,
said disk further comprising a circular wall,
said wall perpendicular to said top surface,
said wall located along a periphery of said disk,
said wall located on said top surface and in communication therewith,
b. extending or generating a substantially elongated counterweight boom,
said boom perpendicular to said top surface,
said boom located along the line through the center of said top surface,
said boom extending distally from said top surface of said disk,
said boom in communication with said imaging system by its proximal terminus only,
c. spinning said support structure around a first axis,
said first axis perpendicular to said top surface of said disk and disposed through a center of combined mass of said disk and said boom,
d. simultaneously spinning said support structure around a second axis,
said second axis orthogonal to said first axis, wherein center of rotation around said second axis is through a center of combined mass of said disk and said boom,
e. placing a mirror precursor material on said top surface of said disk,
f. allowing said precursor material to assume a parabolic shape as a result of said structure spinning around said first and said second axes,
g. subsequently allowing or causing said precursor material to solidify in said parabolic shape.

29. The method of claim 28, wherein said liquid precursor material is stored in liquid form within said system prior to production of said mirror.

30. The method of claim 28, wherein said liquid precursor material is produced in space by liquefying a solid precursor material.

31. The method of claim 28, wherein said precursor material is selected from the group consisting of:
a. alkali metals,
b. aluminum,
c. mercury,
d. metals and alloys thereof,
e. metal glasses and alloys thereof,
f. epoxies and mixtures thereof,
g. epoxies containing thermal expansion coefficient-reducing additives,
h. thermoplastic polymers and mixtures thereof,
i. thermoplastic polymers containing thermal expansion coefficient-reducing additives,
j. thermosetting polymers and mixtures thereof,
k. thermosetting polymers containing thermal expansion coefficient-reducing additives,
l. glasses and mixtures thereof,
m. pitch and mixtures thereof,
n. sugar solutions,
o. aqueous solutions and
p. photocurable polymers.

32. The method of claim 28, further comprising the steps of depositing at least one reflective coating on a surface of said mirror upon its solidification.

33. The method of claim 28, wherein said mirror support material is selected from a group consisting of:
a. shape memory materials,
b. superelastic materials,
c. pliable materials.

34. The method of claim 28, wherein said support structure further comprises at least one heating element.

35. The method of claim 28, wherein said mirror precursor material upon solidification can be subsequently re-melted and re-formed.

36. The method of claim 28, wherein said support structure further comprises at least one source for curing polymers.

37. The method of claim 28, wherein said boom is selected from a group consisting of:
a. deployable structures created via additive manufacturing processes,
b. deployable structures created via extrusion processes,
c. deployable structures made with shape memory materials,
d. deployable foldable structures,
e. deployable telescopic structures,
f. deployable structures comprising pliable members which stiffen during deployment,
g. deployable structures comprising pliable members which form stiff assemblies when assembled together during deployment,
h. pliable members tensioned by a tractor craft,
i. hereinabove members comprising counterweight at their distal termini.

38. The method of claim 28 where said boom is capable of being severed from the rest of said system.
